(19) United States
(12) Patent Application Publication
(10) Pub. No.: US 2024/0054324 A1
(43) Pub. Date: Feb. 15, 2024

(54) DISTRIBUTED LEARNING METHOD AND APPARATUS

(71) Applicant: HUAWEI TECHNOLOGIES CO., LTD., Shenzhen (CN)

(72) Inventors: Gongzheng ZHANG, Hangzhou (CN); Chen XU, Hangzhou (CN); Rong LI, Boulogne Billancourt (FR); Jian WANG, Hangzhou (CN); Jun WANG, Hangzhou (CN)

(21) Appl. No.: 18/486,807

(22) Filed: Oct. 13, 2023

Related U.S. Application Data
(63) Continuation of application No. PCT/CN2022/086900, filed on Apr. 14, 2022.

(30) Foreign Application Priority Data
Apr. 16, 2021 (CN) 202110413617.6

(51) Int. Cl. G06N 3/045; G06N 3/082

(52) U.S. Cl. CPC G06N 3/045; G06N 3/082

(57) ABSTRACT

A distributed learning method and apparatus for combining wireless communication with distributed learning to save resources, and improve performance of distributed learning in a wireless environment. A first node processes first data using a first data model to obtain first intermediate data. The first node sends the first intermediate data to a second node through a first channel. The first channel is updated based on error information of second intermediate data, information about the first channel, and the first intermediate data. The second intermediate data is a result of transmitting the first intermediate data to the second node through the first channel. The first channel is a channel between the first node and the second node.

### CROSS-REFERENCE TO RELATED APPLICATIONS

This application is a continuation of International Application No. PCT/CN2022/086900, filed on Apr. 14, 2022, which claims priority to Chinese Patent Application No. 202110413617.6, filed on Apr. 16, 2021. The disclosures of the aforementioned applications are hereby incorporated by reference in their entireties.

### BACKGROUND

In recent years, the artificial intelligence (AI) technology has made significant progress in fields such as machine vision and natural language processing, and is applied to various devices, but also has high demands on capabilities of the devices. A neural network (NN) model is used as an example. To implement training and inference on the NN model, a device needs to have powerful computing power, which is a great challenge for some devices.

To lower the demands on the capabilities of the devices, the NN model is segmented at an intermediate node at a specific layer or some specific layers of the NN model, and a plurality of obtained NN submodels are deployed on a plurality of devices for training and inference. Currently, operations, such as channel coding, need to be performed on intermediate layer information (a tensor or a vector) of forward propagation and intermediate layer gradient information of back propagation, and transmission is performed between the devices through channels. In this case, encoding and decoding processes occupy a large quantity of resources, resulting in a waste of resources. In addition, currently there is no technical solution that improves performance of distributed learning.

### SUMMARY

Embodiments described herein provide a distributed learning method and apparatus, to combine wireless communication with distributed learning, which saves resources and improve performance of distributed learning in a wireless environment.

To achieve the foregoing objectives, the following technical solutions are used in at least one embodiment.

According to a first aspect, a distributed learning method is provided. The distributed learning method is applied to a first node. The first node includes a first data model. The distributed learning method includes: processing first data by using a first data model to obtain first intermediate data, and sending the first intermediate data to a second node through a first channel. The first channel is updated based on error information of second intermediate data, information about the first channel, and the first intermediate data. The second intermediate data is a result of transmitting the first intermediate data to the second node through the first channel. The first channel is a channel between the first node and the second node.

Based on the distributed learning method according to the first aspect, a channel is combined with a data model, the first channel for transmitting data between the first node and the second node is used as an intermediate layer of the data model, and the first channel is optimized based on the error information of the second intermediate data, the information about the first channel, and the first intermediate data. In this way, training the first channel improves performance of distributed learning. In addition, wireless transmission is enabled to directly serve for distributed learning, to implement integration of communication and computing, which reduces processing complexity and further save resources.

In at least one embodiment, in the distributed learning method according to the first aspect, the first channel includes a second channel and a third channel, and the method further includes: updating the second channel based on the error information of the second intermediate data, information about the third channel, and the first intermediate data.

In this way, the first channel between the first node and the second node is split into the second channel and the third channel. The second channel is a controllable part or a controllable environment. Updating the controllable part (that is, the second channel) in the first channel improves performance of distributed learning.

In at least one embodiment, the updating the second channel based on the error information of the second intermediate data, information about the third channel, and the first intermediate data includes: receiving first information sent by the second node, and updating the second channel based on the first information and the first intermediate data. The first information is determined based on the error information of the second intermediate data and the information about the third channel.

In this way, the controllable part (that is, the second channel) of the first channel is updated based on the first information and the first intermediate data, to improve performance of distributed learning.

Optionally, the first node receives, through a fourth channel, the first information sent by the second node. Correspondingly, the second node sends the first information to the first node through the fourth channel. That is, a channel between the first node and the second node in a reverse training process is different from a channel between the first node and the second node in a forward training process, for example, in terms of frequency points or transmission mechanisms.

For example, the first information is transmitted on a conventional data/control channel, or is transmitted on another physical/logical channel dedicated to NN training. A transmission process includes operations of reducing a data amount such as sparseness, quantization, and/or entropy coding, or includes operations of reducing a transmission error such as channel coding.

In at least one embodiment, the distributed learning method according to the first aspect further includes: sending a first signal to the second node through the first channel. The first signal is for determining the information about the first channel.

Optionally, the first signal is a pilot signal, and the first node sends a pilot and set a parameter of a controllable part of a channel, to enable the second node to perform channel estimation to obtain channel information, so that the channel or the first data model is updated, to improve performance of distributed learning.

In at least one embodiment, the updating the second channel based on the error information of the second intermediate data, information about the third channel, and the first intermediate data includes: receiving a third signal from the second node through the first channel; obtaining first information based on the third signal; and updating the second channel based on the first information and the first intermediate data. The third signal is a signal obtained after a fourth signal is transmitted to the first node through the first channel, and the fourth signal includes a signal generated by mapping the error information of the second intermediate data to an air interface resource. The first information is determined based on the error information of the second intermediate data and the information about the third channel.

In this way, the first information is obtained through over-the-air computation by using the propagation characteristic of a signal on an air interface resource, so that the second channel is updated based on the first channel and the first intermediate data, which improves performance of distributed learning and reduce pilot overheads.

In at least one embodiment, the distributed learning method according to the first aspect further includes sending a fifth signal to the second node through the first channel. The fifth signal includes a signal generated by mapping third intermediate data to an air interface resource, and the third intermediate data is for updating the first channel.

In this way, based on channel reciprocity, by using the propagation characteristic of a signal on an air interface resource, the second node is enabled through over-the-air computation to obtain the third intermediate data and the channel information, to avoid channel estimation, which reduces pilot overheads.

In at least one embodiment, the distributed learning method according to the first aspect further includes updating the first data model based on error information of the first intermediate data to obtain a new first data model. In this way, the first node updates the first data model, to improve performance of distributed learning.

In at least one embodiment, the distributed learning method according to the first aspect further includes receiving second information sent by the second node. The second information is for obtaining the error information of the first intermediate data. In this way, the first node updates the first data model based on the error information of the first intermediate data, to improve performance of distributed learning.

In at least one embodiment, the second information includes the error information of the first intermediate data. Alternatively, the second information includes the error information of the second intermediate data and the information about the first channel, and the error information of the second intermediate data and the information about the first channel are for determining the error information of the first intermediate data. In other words, the second information is determined by the second node. Alternatively, the second information is obtained through over-the-air computation, which saves resources.

In at least one embodiment, the distributed learning method according to the first aspect further includes: receiving an eighth signal from the second node; and obtaining the error information of the first intermediate data based on the eighth signal. Optionally, the eighth signal is a signal obtained after a seventh signal is transmitted to the first node through a channel, and the seventh signal includes a signal generated by mapping the error information of the second intermediate data to an air interface resource.

In this way, over-the-air computation of the gradient of the intermediate layer in the first data model is implemented through a process of propagation of a signal in the air, which reduces pilot overheads.

According to a second aspect, a distributed learning method is provided. The distributed learning method is applied to a second node. The second node includes a second data model. The distributed learning method includes: receiving second intermediate data through a first channel; and processing the second intermediate data by using the second data model to obtain output data. The second intermediate data is a result of transmitting first intermediate data sent by a first node to the second node through the first channel. The first channel is updated based on error information of the second intermediate data, information about the first channel, and the first intermediate data. The first channel is a channel between the first node and the second node.

Optionally, the second node determines a new channel based on the error information of the second intermediate data, channel information of a channel, and the first intermediate data.

In at least one embodiment, in the distributed learning method according to the second aspect, the first channel includes a second channel and a third channel, and the method further includes sending the error information of the second intermediate data and information about the third channel to the first node.

In at least one embodiment, the sending the error information of the second intermediate data and information about the third channel to the first node includes sending first information to the first node. The first information is determined based on the error information of the second intermediate data and the information about the third channel.

In at least one embodiment, the distributed learning method according to the second aspect further includes: receiving a second signal from the first node through the first channel; and obtaining the information about the first channel based on the second signal. The second signal is a signal obtained after a first signal is transmitted to the second node through the first channel. The first signal is for determining the information about the first channel.

In at least one embodiment, the sending the error information of the second intermediate data and information about the third channel to the first node includes sending a fourth signal to the first node through the first channel. The fourth signal includes a signal generated by mapping the error information of the second intermediate data to an air interface resource.

In at least one embodiment, the distributed learning method according to the second aspect further includes: receiving a sixth signal from the first node through the first channel; obtaining third information based on the sixth signal; and updating the second channel based on the third information and the error information of the second intermediate data. The sixth signal is a signal obtained after a fifth signal is transmitted to the second node through the first channel. The fifth signal includes a signal generated by mapping third intermediate data to an air interface resource. The third intermediate data is for updating the first channel. The third information is determined based on the third intermediate data and the information about the third channel.

In at least one embodiment, the distributed learning method according to the second aspect further includes sending second information to the first node. The second information is for obtaining the error information of the first intermediate data.

In at least one embodiment, the second information includes the error information of the first intermediate data. Alternatively, the second information includes the error information of the second intermediate data and the information about the first channel, and the error information of the second intermediate data and the information about the first channel are for determining the error information of the first intermediate data.

In at least one embodiment, the distributed learning method according to the second aspect further includes updating the second data model based on the output data to obtain a new second data model.

In at least one embodiment, the distributed learning method according to the second aspect further includes sending a seventh signal to the first node. Optionally, the seventh signal includes a signal generated by mapping the error information of the second intermediate data to an air interface resource.

According to a third aspect, a distributed learning apparatus is provided. The distributed learning apparatus includes a first data model. The apparatus includes a processing module and a transceiver module.

The processing module is configured to process first data by using the first data model to obtain first intermediate data. The transceiver module is configured to send the first intermediate data to a second node through a first channel. The first channel is updated based on error information of second intermediate data, information about the first channel, and the first intermediate data, the second intermediate data is a result of transmitting the first intermediate data to the second node through the first channel, and the first channel is a channel between the distributed learning apparatus and the second node.

In at least one embodiment, the processing module is further configured to update the second channel based on the error information of the second intermediate data, information about the third channel, and the first intermediate data.

In at least one embodiment, the transceiver module is further configured to receive first information sent by the second node. The processing module is further configured to update the second channel based on the first information and the first intermediate data. The first information is determined based on the error information of the second intermediate data and the information about the third channel.

In at least one embodiment, the transceiver module is further configured to receive a third signal from the second node through the first channel. The third signal is a signal obtained after a fourth signal is transmitted to the distributed learning apparatus through the first channel. The fourth signal includes a signal generated by mapping the error information of the second intermediate data to an air interface resource.

the processing module is further configured to obtain first information based on the third signal. The first information is determined based on the error information of the second intermediate data and the information about the third channel.

The processing module is further configured to update the second channel based on the first information and the first intermediate data.

In at least one embodiment, the transceiver module is further configured to send a first signal to the second node through the first channel. The first signal is for determining the information about the first channel.

In at least one embodiment, the transceiver module is further configured to send a fifth signal to the second node through the first channel. The fifth signal includes a signal generated by mapping third intermediate data to an air interface resource, and the third intermediate data is for updating the first channel.

In at least one embodiment, the processing module is further configured to update the first data model based on error information of the first intermediate data to obtain a new first data model.

In at least one embodiment, the transceiver module is further configured to receive second information sent by the second node. The second information is for obtaining the error information of the first intermediate data.

In at least one embodiment, the second information includes the error information of the first intermediate data. Alternatively, the second information includes the error information of the second intermediate data and the information about the first channel, and the error information of the second intermediate data and the information about the first channel are for determining the error information of the first intermediate data.

The transceiver module in the third aspect includes a receiving module and a sending module. The receiving module is configured to receive data and/or signaling from the second node. The sending module is configured to send data and/or signaling to the second node. A specific implementation of the transceiver module is not specifically limited in at least one embodiment.

Optionally, the distributed learning apparatus according to the third aspect further includes a storage module. The storage module stores a program or instructions. In response to the processing module executing the program or the instruction, the distributed learning apparatus according to the third aspect is enabled to perform the method according to the first aspect.

The distributed learning apparatus according to the third aspect is a first node, or is, for example, a chip (system) or another component or assembly that is arranged in the first node. This is not limited in at least one embodiment.

In addition, for technical effects of the distributed learning apparatus according to the third aspect, refer to the technical effects of the distributed learning method according to at least one embodiment in the first aspect. Details are not described herein again.

According to a fourth aspect, a distributed learning apparatus is provided. The distributed learning apparatus includes a second data model. The apparatus includes a processing module and a transceiver module.

The transceiver module is configured to receive second intermediate data through a first channel. The second intermediate data is a result of transmitting first intermediate data sent by a first node to the distributed learning apparatus through the first channel, the first channel is updated based on error information of the second intermediate data, information about the first channel, and the first intermediate data, and the first channel is a channel between the first node and the distributed learning apparatus.

The processing module is configured to process the second intermediate data by using the second data model to obtain output data.

In at least one embodiment, the first channel includes a second channel and a third channel. The transceiver module is further configured to send the error information of the second intermediate data and information about the third channel to the first node.

In at least one embodiment, the transceiver module is further configured to send first information to the first node. The first information is determined based on the error information of the second intermediate data and the information about the third channel.

In at least one embodiment, the transceiver module is further configured to receive a second signal from the first node through the first channel, where the second signal is a signal obtained after a first signal is transmitted to the distributed learning apparatus through the first channel, and the first signal is for determining the information about the first channel. The processing module is further configured to obtain the information about the first channel based on the second signal.

In at least one embodiment, the transceiver module is further configured to send a fourth signal to the first node through the first channel. The fourth signal includes a signal generated by mapping the error information of the second intermediate data to an air interface resource.

In at least one embodiment, the transceiver module is further configured to receive a sixth signal from the first node through the first channel. The sixth signal is a signal obtained after a fifth signal is transmitted to the distributed learning apparatus through the first channel, the fifth signal includes a signal generated by mapping third intermediate data to an air interface resource, and the third intermediate data is for updating the first channel.

The processing module is further configured to obtain third information based on the sixth signal. The third information is determined based on the third intermediate data and the information about the third channel.

The processing module is further configured to update the second channel based on the third information and the error information of the second intermediate data.

In at least one embodiment, the transceiver module is further configured to send second information to the first node. The second information is for obtaining the error information of the first intermediate data.

In at least one embodiment, the second information includes the error information of the first intermediate data. Alternatively, the second information includes the error information of the second intermediate data and the information about the first channel, and the error information of the second intermediate data and the information about the first channel are for determining the error information of the first intermediate data.

In at least one embodiment, the processing module is further configured to update the second data model based on the output data to obtain a new second data model.

The transceiver module in the fourth aspect includes a receiving module and a sending module. The receiving module is configured to receive data and/or signaling from a first node. The sending module is configured to send data and/or signaling to the first node. A specific implementation of the transceiver module is not specifically limited in at least one embodiment.

Optionally, the distributed learning apparatus according to the fourth aspect further includes a storage module. The storage module stores a program or instructions. In response to the processing module executing the program or the instruction, the distributed learning apparatus according to the fourth aspect is enabled to perform the method according to the second aspect.

The distributed learning apparatus according to the fourth aspect is a second node, or is, for example, a chip (system) or another component or assembly that is arranged in the second node. This is not limited in at least one embodiment.

In addition, for technical effects of the distributed learning apparatus according to the fourth aspect, refer to the technical effects of the distributed learning method according to at least one embodiment in the first aspect. Details are not described herein again.

According to a fifth aspect, a distributed learning apparatus is provided. The distributed learning apparatus includes a processor. The processor is coupled to a memory, and the memory is configured to store a computer program.

The processor is configured to execute the computer program stored in the memory, to enable the distributed learning apparatus to perform the distributed learning method according to at least one embodiment in the first aspect and the second aspect.

In at least one embodiment, the distributed learning apparatus according to the fifth aspect further includes a transceiver. The transceiver is a transceiver circuit or an input/output port. The transceiver is configured for the distributed learning apparatus to communicate with another device.

The input port is configured to implement the receiving functions included in the first aspect and the second aspect, and the output port is configured to implement the sending functions included in the first aspect and the second aspect.

In at least one embodiment, the distributed learning apparatus according to the fifth aspect is a first node or a second node, or a chip or a chip system arranged inside the first node or the second node.

In addition, for technical effects of the distributed learning apparatus according to the fifth aspect, refer to the technical effects of the distributed learning method according to any implementation in the first aspect and the second aspect. Details are not described herein again.

According to a sixth aspect, a communication system is provided. The communication system includes a first node and a second node.

According to a seventh aspect, a chip system is provided. The chip system includes a processor and an input/output port. The processor is configured to implement the processing functions in the first aspect and the second aspect, and the input/output port is configured to implement the sending and receiving functions in the first aspect and the second aspect. Specifically, the input port is configured to implement the receiving functions included in the first aspect and the second aspect, and the output port is configured to implement the sending functions included in the first aspect and the second aspect.

In at least one embodiment, the chip system further includes a memory, and the memory is configured to store program instructions and data for implementing the functions in the first aspect and the second aspect.

The chip system includes a chip, or includes a chip and another discrete component.

According to an eighth aspect, a computer-readable storage medium is provided, including a computer program or instructions. In response to the computer program or the instructions being run on a computer, the distributed learning method according to at least one embodiment in the first aspect and the second aspect is performed.

According to a ninth aspect, a computer program product is provided, including a computer program or instructions. In response to the computer program or the instructions being run on a computer, the distributed learning method according to at least one embodiment in the first aspect and the second aspect is performed.

According to a tenth aspect, a computer program is provided. In response to the computer program being executed on a computer, the method according to any implementation in the first aspect and the second aspect is performed.

### BRIEF DESCRIPTION OF DRAWINGS

FIG. 1 is a schematic diagram of an architecture of a communication system according to at least one embodiment;

FIG. 2 is a schematic diagram of a fully-connected neural network according to at least one embodiment;

FIG. 3 is a schematic diagram of gradient descent according to at least one embodiment;

FIG. 4 is a schematic diagram of neural network training according to at least one embodiment;

FIG. 5 is a schematic diagram of a type of neural network segmentation according to at least one embodiment;

FIG. 6 is a schematic diagram of another type of neural network segmentation according to at least one embodiment;

FIG. 7 is a schematic diagram of still another type of neural network segmentation according to at least one embodiment;

FIG. 8 is a schematic diagram of interaction of a distributed learning method according to at least one embodiment;

FIG. 9A and FIG. 9B are a schematic diagram of application of a distributed learning method according to at least one embodiment;

FIG. 10A and FIG. 10B are a schematic diagram of application of another distributed learning method according to at least one embodiment;

FIG. 11A and FIG. 11B are a schematic diagram of application of still another distributed learning method according to at least one embodiment;

FIG. 12(a), FIG. 12(b), and FIG. 12(c) are a schematic diagram of interaction of another distributed learning method according to at least one embodiment;

FIG. 13 is a schematic diagram of a structure of a distributed learning apparatus according to at least one embodiment; and

FIG. 14 is a schematic diagram of a structure of another distributed learning apparatus according to at least one embodiment.

### DESCRIPTION OF EMBODIMENTS

The following describes technical solutions of at least one embodiment with reference to the accompanying drawings.

The technical solutions in at least one embodiment is applied to various communication systems, for example, a Wireless Fidelity (Wi-Fi) system, a vehicle to everything (V2X) communication system, a device-to-device (D2D) communication system, an Internet of vehicles communication system, a short-distance wireless communication system, a satellite communication system, a NarrowBand-Internet of Things (NB-IoT) system, a long-term evolution (LTE) system, a fifth generation (5G) mobile communication system such as a new radio (NR) system, and a future communication system such as a sixth generation (6G) mobile communication system. The technical solutions in at least one embodiment is applied to the following application scenarios: enhanced mobile broadband (eMBB), URLLC (URLLC), and enhanced machine-type communication (eMTC).

All aspects, embodiments, or features are presented herein by describing a system that includes a plurality of devices, components, modules, and the like. Each system includes another device, component, module, and the like, and/or does not include all devices, components, modules, and the like discussed with reference to the accompanying drawings. In addition, a combination of these solutions is used.

In addition, in at least one embodiment, terms such as “example” and “for example” represent giving an example, an illustration, or a description. Any embodiment or design scheme described as an “example” in at least one embodiment should not be explained as being more preferred or having more advantages than another embodiment or design scheme. Exactly, the use of the term “example” is intended to present a concept in a specific manner.

The network architecture and the service scenario described in at least one embodiment are intended to describe the technical solutions in at least one embodiment more clearly, but constitute no limitation on the technical solutions provided in at least one embodiment. A person of ordinary skill in the art learns that the technical solutions provided in at least one embodiment are also applicable to a similar technical problem as the network architecture evolves and a new service scenario emerges.

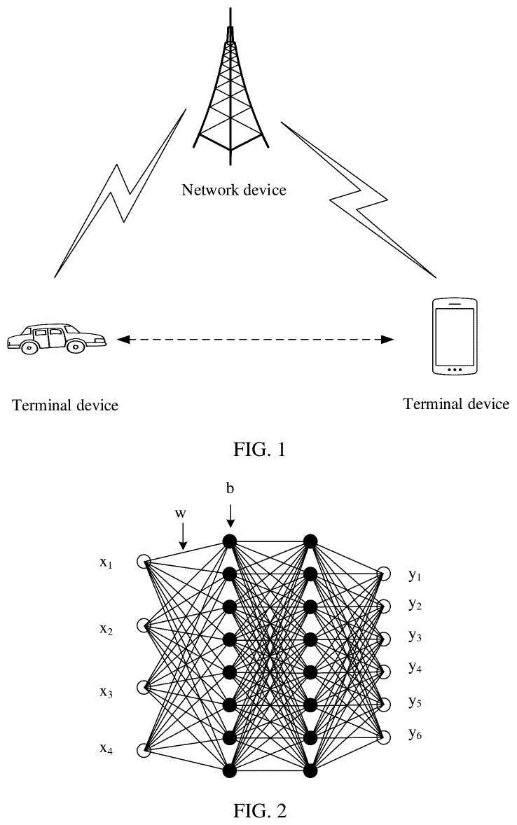

For ease of understanding at least one embodiment, the following describes in detail a communication system applicable to embodiments described herein by using a communication system shown in FIG. 1 as an example. For example, FIG. 1 is a schematic diagram of an architecture of a communication system to which a distributed learning method according to at least one embodiment is applicable.

The communication system includes a first node and a second node. The first node is a terminal device, and the second node is a network device. Alternatively, the first node is a network device, and the second node is a terminal device. Alternatively, the first node is a terminal device, and the second node is a terminal device. As shown in FIG. 1, the communication system includes a terminal device, and there is one or more terminal devices. The communication system further includes a network device.

The network device is a device that is located on a network side of the communication system and that has wireless sending and receiving functions, or a chip or a chip system that is arranged in the device. The network device includes, but is not limited to, an access point (AP) in a wireless fidelity (Wi-Fi) system such as a home gateway, a router, a server, a switch, or a bridge, an evolved NodeB (eNB), a radio network controller (RNC), a home base station (such as a home evolved NodeB or a home NodeB, HNB), a radio relay node, a radio backhaul node, or a transmission point (TRP, or TP), or is a gNB or a transmission point (TRP or TP) in 5G, for example, an NR system, or one antenna panel or a group of (including a plurality of antenna panels) antenna panels of a base station in a 5G system, or is a network node forming a gNB or a transmission point, for example, a baseband unit (BBU), a distributed unit (DU), a road side unit (RSU) having a base station function or the like. The network device is alternatively a radio controller in a cloud radio access network (CRAN) scenario, or a network device in a future evolved public land mobile network (PLMN), or a wearable device or an in-vehicle device, and further include a device that functions as a base station in device-to-device (D2D), vehicle-to-everything (V2X), machine-to-machine (M2M) communication, or Internet of Things (IoT) communication.

The terminal device is a terminal that accesses the communication system and that has wireless sending and receiving functions, or a chip or a chip system that is arranged in the terminal. The terminal device is also referred to as user equipment (UE), a user apparatus, an access terminal, a subscriber unit, a subscriber station, a mobile console, a mobile station (MS), a remote station, a remote terminal, a mobile device, a user terminal, a terminal, a terminal unit, a terminal station, a terminal apparatus, a wireless communication device, a user agent, or a user apparatus. For example, the terminal device in at least one embodiment is a mobile phone (mobile phone), a wireless data card, a personal digital assistant (PDA) computer, a laptop computer (laptop computer), a tablet computer (Pad), a computer with wireless sending and receiving functions, a machine-type communication (MTC) terminal, a virtual reality (VR) terminal device, an augmented reality (AR) terminal device, an Internet of Things (IoT) terminal device, a wireless terminal in industrial control (industrial control), a wireless terminal in unmanned driving (self-driving), a wireless terminal in remote medical (remote medical), a wireless terminal in a smart grid (smart grid), a wireless terminal in transportation safety (transportation safety), a wireless terminal in a smart city (smart city), a wireless terminal (such as a game console, a smart television, a smart speaker, a smart refrigerator, and a fitness apparatus) in a smart home (smart home), an in-vehicle terminal, or an RSU having a terminal function. The access terminal is a cellular phone (cellular phone), a cordless phone, a Session Initiation Protocol (SIP) phone, a wireless local loop (WLL) station, a personal digital assistant (PDA), a handheld device (handset) with a wireless communication function, a computing device, another processing device connected to a wireless modem, a wearable device, or the like. For another example, the terminal device in at least one embodiment is an express delivery terminal (for example, a device that monitors a location of a vehicle carrying goods or a device that monitors a temperature and humidity of goods) in smart logistics, a wireless terminal (for example, a wearable device that collects related data of livestock and poultry) in smart agriculture, a wireless terminal (for example, a smart elevator, a fire monitoring device, and a smart meter) in a smart building, a wireless terminal (for example, a wearable device that monitors a physiological status of a person or an animal) in smart medical, a wireless terminal (such as a smart bus, a smart vehicle, a shared bicycle, a charging pile monitoring device, a smart traffic light, smart monitoring devices, and smart parking devices) in intelligent transportation, or a wireless terminal (such as a vending machine, a self-service checkout machine, and an unmanned convenience store) in smart retail. For another example, the terminal device in at least one embodiment is an in-vehicle module, an in-vehicle module, an in-vehicle component, an in-vehicle chip, or an in-vehicle unit that is built in a vehicle as one or more components or units. The vehicle implements, through the in-vehicle module, the in-vehicle module, the in-vehicle component, the in-vehicle chip, or the in-vehicle unit, the distributed learning method provided in at least one embodiment.

The distributed learning method provided in at least one embodiment is applied to between any two nodes shown in FIG. 1, for example, between terminal devices and between a terminal device and a network device. For specific implementation, refer to the following method embodiments. Details are not described herein again.

The solutions in at least one embodiment is further applied to another communication system, and a corresponding name is also replaced with a name of a corresponding function in the another communication system.

FIG. 1 is merely a simplified schematic diagram of an example for ease of understanding. The communication system further includes another device that is not shown in FIG. 1.

In addition, a person of ordinary skill in the art learns that, with evolution of a network architecture and emergence of a new service scenario, the technical solutions provided in at least one embodiment are also applicable to a similar technical problem.

To make embodiments described herein clearer, the following describes some content and concepts related to at least one embodiment together.

1. Neural Network

A neural network is an algorithm network that performs learning, summarization, and conclusion, and is built in a computing node in a form of neural network software or hardware, for example, a training program or an executable script of a neural network. Generally, a deep neural network (DNN) model is used as an example. A DNN model includes a plurality of layers of neurons (operators). Each layer has a plurality of inputs and a plurality of outputs. The input or output is a multi-dimensional array, also referred to as a tensor (tensor). Each layer has one or more weighted values, referred to as weights. An output result of a specific layer, also referred to as an eigenvalue, is equal to a result of a mathematical operation, such as multiplication, of an input and a weight of the layer, and usually relates to a matrix multiplication operation.

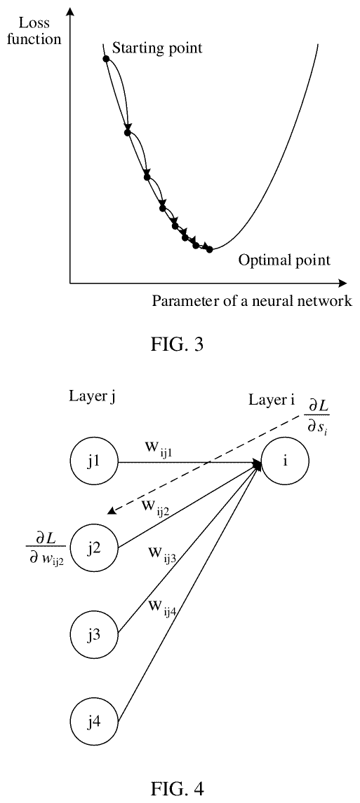

A fully-connected neural network is a neural network, and the fully-connected neural network is also referred to as a multi-layer perceptron (MLP). One MLP includes one input layer, one output layer, and a plurality of hidden layers (also referred to as intermediate layers), and each layer includes a plurality of neurons. Neurons included in two adjacent layers of neurons are connected pairwise, as shown in FIG. 2.

For two adjacent layers of neurons, an output h of a neuron at a lower layer is a weighted sum of all neurons x at an upper layer connected to the neuron at the lower layer and passes through an activation function. The matrix is represented as the following formula: h=f(wxx+b), where w is a weight matrix, b is a bias vector, and f(is an activation function. Then, the output y of the neural network is recursively expressed as y=fₜ(wₜ×fₜ₋₁( . . . )+bₜ), where t is a quantity of layers of neurons included in the fully-connected neural network.

2. Neural Network Training

A neural network is understood as a mapping relationship between an input data set and an output data set. Generally, the neural network is randomly initialized, and a process of obtaining the mapping relationship based on random w and random b by using existing data is referred to as neural network training.

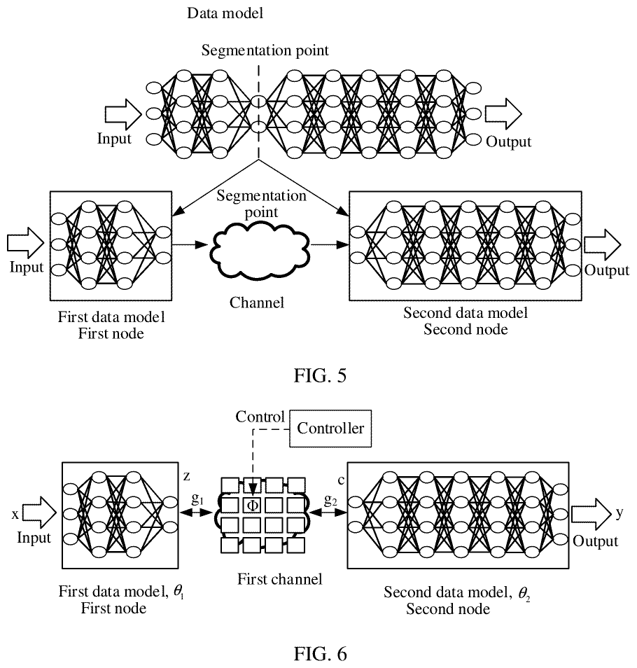

For example, a training manner includes evaluating output data of the neural network by using a loss function (loss function), to obtain and backpropagate error information. As shown in FIG. 3, a weight matrix w and a bias vector b is iteratively optimized through the gradient descent method, and optimal w and optimal b is obtained in response to a value of the loss function reaching a minimum value.

For example, a gradient descent process is expressed as a formula (1):

$${θ}^{′} ← θ - η \times \frac{\partial L}{\partial θ} or {θ}^{′} = θ - η \times \frac{\partial L}{\partial θ} . \qquad ( 1 )$$

A parameter (for example, the weight w and the bias b) is optimized by using the foregoing formula (1). In the foregoing formula (1), θ′ is a value (which is also referred to as an updated value) of a parameter before the optimization, θ is a value of the parameter before the optimization, L is a loss function, η is a learning rate and is for controlling a stride of gradient descent, and the mathematical symbol ← indicates to assign a right side to a left side.

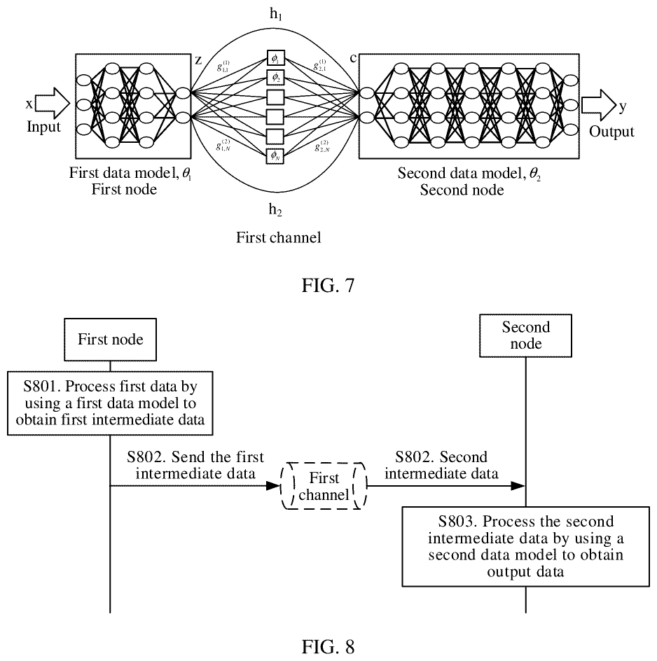

With reference to FIG. 4, in a backpropagation process, a chain rule for obtaining a partial derivative is used, to be specific, a gradient of a parameter of a neuron at a previous layer (layer j) is calculated through recursion from a gradient of a parameter of a neuron (layer i) at a next layer as the following formula (2):

$$\frac{\partial L}{\partial {w}_{ij2}} = \frac{\partial L}{\partial {s}_{i}} \times \frac{\partial {s}_{i}}{\partial {w}_{ij2}} . \qquad ( 2 )$$

In the foregoing formula (2), L is a loss function, wᵢⱼ is a weight of a connection between a neuron i and a neuron j, sᵢ is a weighted sum of inputs on the neuron i, that is, sᵢ=wᵢⱼ₁×sⱼ₁+wᵢⱼ₂×sⱼ₂+wᵢⱼ₃×sⱼ₃+wᵢⱼ₄×sⱼ₄,

$$\frac{\partial L}{\partial {s}_{i}}$$

is a gradient

$$\frac{\partial L}{\partial {s}_{i}}$$

transferred from a next layer (layer i) of the layer j to the layer j, and

$$\frac{\partial L}{\partial {s}_{i}}$$

is referred to as an intermediate layer gradient, that is, the layer i is considered as an intermediate layer.

3. Neural Network Segmentation

Neural network segmentation: A neural network is segmented into a plurality of sub-neural networks at a specific intermediate layer based on computing powers and communication capabilities of nodes, and the sub-neural networks are deployed on a plurality of nodes respectively.

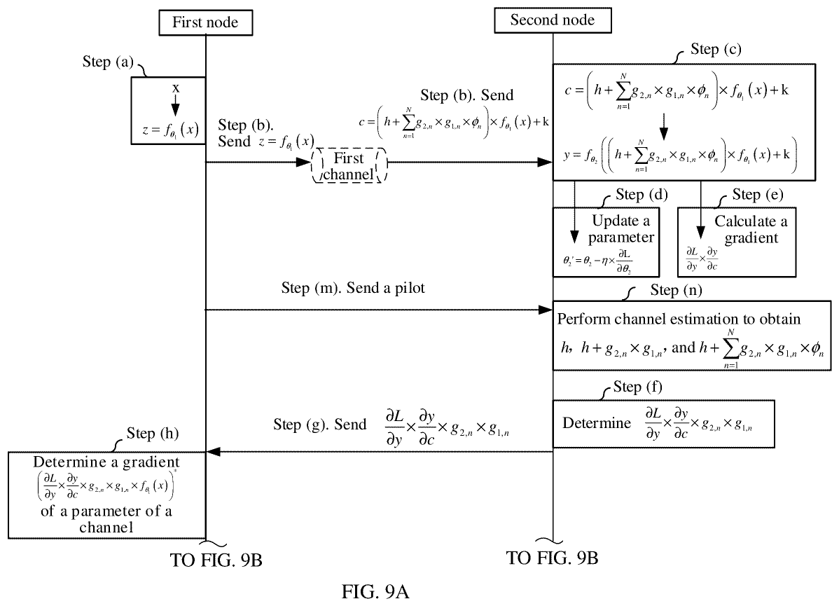

With reference to FIG. 5, a first data model and a second data model are obtained after a data model is segmented at the intermediate layer. In a forward process of training or inference, the first node processes input data by using the first data model to obtain intermediate data, and transmits the intermediate data to the second node through a channel. Then, the second node processes the intermediate data by using the second data model to obtain output data. In a reverse process of training, the second node determines error information of the second data model based on the output data, updates a parameter of the second data model, and sends the error information of the second data model to the first node. The first node determines error information of the first data model based on the error information of the second data model, and updates a parameter of the first data model.

4. Parameter of the First Data Model, Parameter of the Second Data Model, Parameter of a First Channel, and Information about the First Channel

Parameter of the first data model: A parameter θ₁ of the first data model is a weight and/or a bias corresponding to the first data model.

Parameter of the second data model: A parameter θ₂ of the second data model is a weight and/or a bias corresponding to the second data model.

In at least one embodiment, the first channel includes a controllable part, and further includes an uncontrollable part. The controllable part includes a controllable environment, and the uncontrollable part includes an uncontrollable environment between two nodes. Alternatively, the first channel includes a trainable channel affected by a controllable part, and further includes a direct channel formed by an uncontrollable part.

Controllable environment: A controllable unit is deployed in an environment to adjust a radio channel environment.

For example, the controllable unit includes an active device such as a relay, a distributed antenna, or an active intelligent reflective surface. Alternatively, the controllable unit includes a passive device such as a passive intelligent reflective surface.

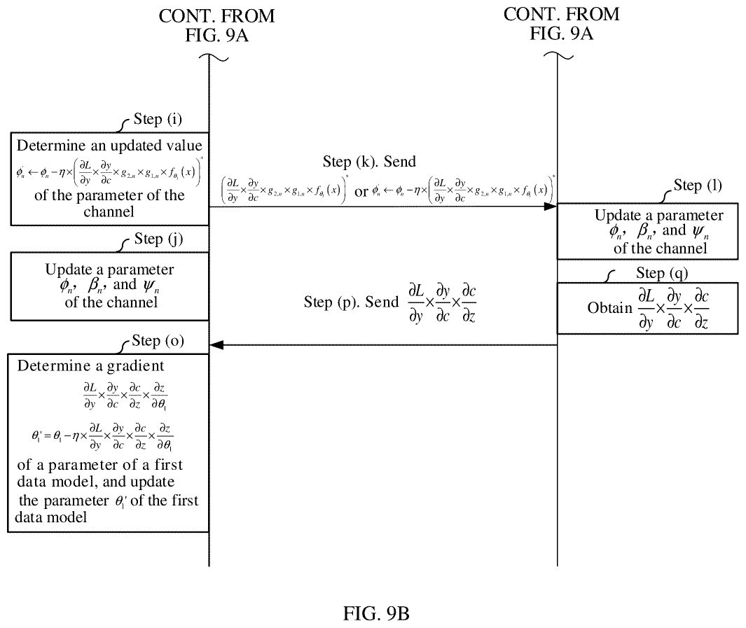

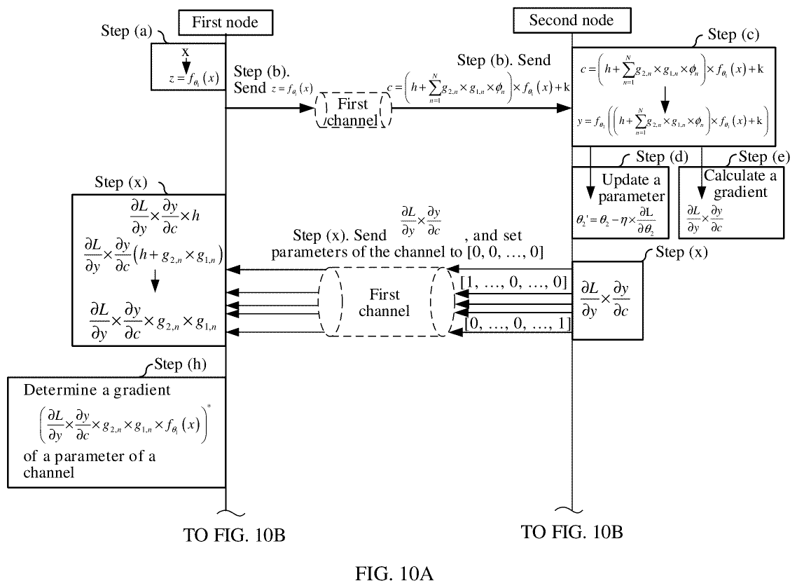

With reference to FIG. 6 or FIG. 7, the first channel includes a second channel and further includes a third channel. In at least one embodiment, the controllable part or the trainable channel affected by the controllable part is referred to as a second channel, and the uncontrollable part or the channel formed by the uncontrollable part is referred to as a third channel.

FIG. 6 is a schematic diagram of application of a distributed learning method according to at least one embodiment. FIG. 7 is a schematic diagram of application of another distributed learning method according to at least one embodiment. As shown in FIG. 6 or FIG. 7, the first node includes the first data model, the second node includes the second data model, and the first node communicates with the second node through the first channel. FIG. 6 mainly differs from FIG. 7 in that display forms of the first channel are different.

For example, the first channel includes the controllable part and the uncontrollable part, or the first channel includes the trainable channel affected by the controllable part and the channel formed by the uncontrollable part. With reference to FIG. 6 and FIG. 7, the first channel between the first node and the second node is represented as g₁×Φ×g₂+h or h+Σₙ₌₁^{N}g_{2,n}×g_{1,n}×ϕₙ, where
g₁, g₂ and h are related information of the uncontrollable part or related information of the channel formed by the uncontrollable part, g₁ is a channel from the first node to the controllable part (or referred to as the trainable channel affected by the controllable environment or the controllable part), g₂ is a channel from the second node to the controllable part (or referred to as the trainable channel affected by the controllable environment or the controllable part), and h is a direct channel from the first node to the second node. N is a dimension, for example, a quantity of controllable units, of the first channel (for example, the controllable environment or the controllable part) serving as the intermediate layer. (P is a parameter of the controllable part or a parameter of the trainable channel affected by the controllable part, and (P is a response of the controllable part (or referred to as the trainable channel affected by the controllable environment or the controllable part). For example, (P includes an amplitude, a phase effect, and the like.

For example, the n^{th} element of the response (P of the controllable part is expressed as a formula (3):

ϕₙ=βₙ×e^{jψn}, where (3)

βₙ is an amplitude of the response, e is a natural constant, e is approximately equal to 2.71828, ψₙ, is a phase of the response, j is an imaginary unit, and j²=−1.

In at least one embodiment, the parameter of the first channel includes one or more of the following: g₁, g₂, h, and Φ. The parameter of the second channel includes Φ. The information about the first channel includes information obtained based on one or more of g₁, g₂, h, and Φ. Information about the third channel includes information obtained based on one or more of g₁, g₂, and h.

In the conventional technology, communication transmission is designed for lossless transmission. To ensure error-free transmission of information, in a forward process and a reverse process, channel encoding needs to be performed on information transmitted between the first node and the second node, and received information needs to be decoded.

A characteristic of over-parameterization (that is, a quantity of parameters is greater than a quantity of training samples) of the neural network and a training method, represented by random gradient descent, of the neural network enable the neural network to have a good error tolerance capability. Therefore, in a distributed learning process, a demand for lossless transmission of information is low. However, encoding and decoding processes occupy a large quantity of resources, resulting in a waste of resources. A design of decoupling learning of the neural network from communication causes redundancy of radio resource utilization. In addition, this solution cannot improve performance of distributed learning.

Embodiments described herein propose to combine a channel with distributed learning and perform joint training on the channel and the neural network by taking the channel as a part of the neural network, so that resources is saved, and performance of distributed learning is improved.

The distributed learning method provided in at least one embodiment is applied to a plurality of waveform systems such as a single carrier, a discrete Fourier transform spread orthogonal frequency division multiplexing (DFT-s-OFDM) system, a cyclic prefix orthogonal frequency division multiplexing (SC-OFDM) system, and an orthogonal time-frequency space (OTFS) system. Radio channel responses of the systems is modeled as linear systems. A main difference between the systems is that resource definitions are different. For example, the single carrier defines a symbol in time domain, and the OTFS and like is considered as performing further linear transformations on the symbol.

The distributed learning method provided in at least one embodiment is applicable to a scenario with one or more antennas, and mapping (that is, precoding) between a neuron and an antenna is also a linear transformation.

The distributed learning method provided in at least one embodiment is applicable to a single AI task and a multi-task or multi-view scenario. In the multi-task scenario, there is a plurality of second data models, configured for a plurality of inference tasks. The plurality of second data models are separately updated. The first data model and the controllable environment need to be updated by integrating (for example, weighting) intermediate layer error information of the plurality of second data models. In the multi-view scenario, there is a plurality of first data models, configured to process data of different views for subsequent inference of the second data model. The update of the controllable environment is related to transmission manners of intermediate layer inference outputs of the plurality of first data models. For example, in response to orthogonal/non-orthogonal multiple access being used, the plurality of first data models is separately updated. The distributed learning method provided in at least one embodiment is described by using an example in which the distributed learning method is applied to a single AI task.

The technical solutions of this solution is applied to a multi-hop network scenario, that is, a case in which a neural network is segmented into three or more.

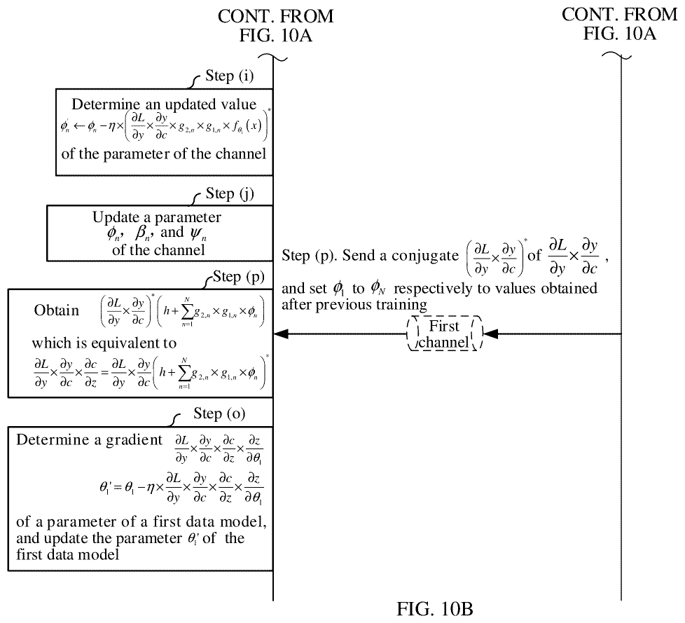

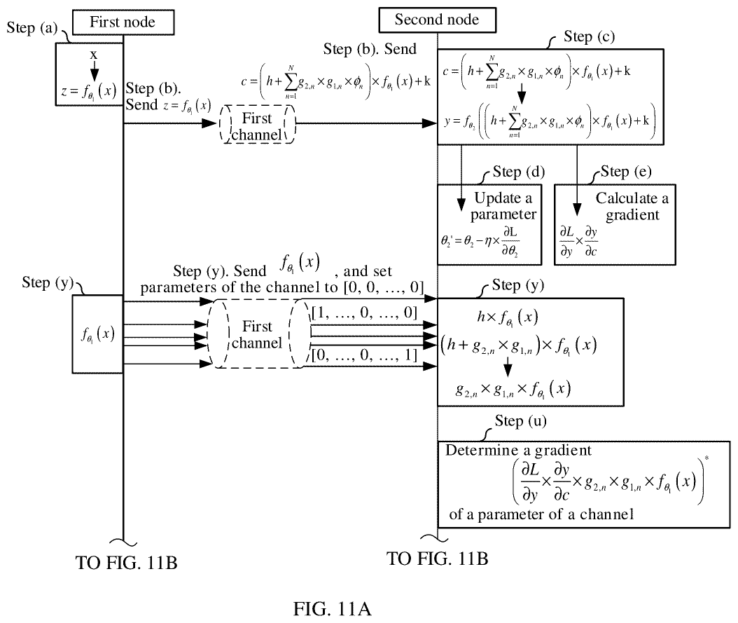

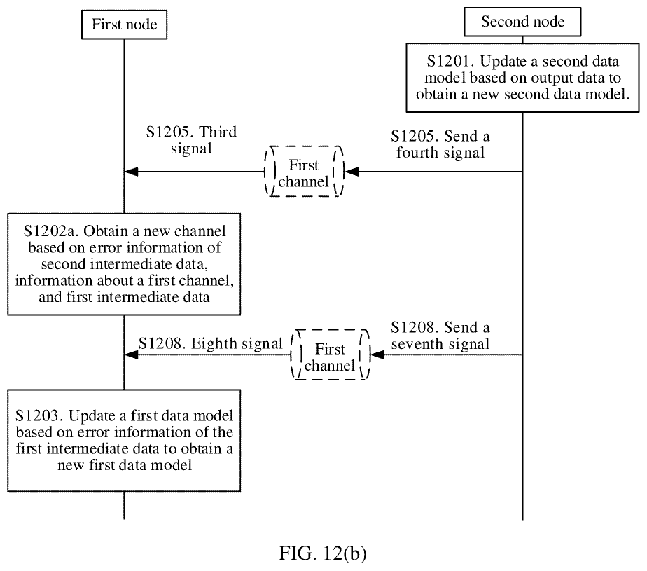

The following describes in detail the distributed learning method provided in at least one embodiment with reference to FIG. 8 to FIG. 12A and FIG. 12B. FIG. 9A to FIG. 11B are schematic diagrams of at least one embodiment of a distributed learning method according to at least one embodiment. In response to the methods shown in FIG. 8, FIG. 12(a), FIG. 12(b), and FIG. 12(c) being described, content in FIG. 9A to FIG. 11B is described as examples.

For example, FIG. 8 is a schematic diagram of interaction of a distributed learning method according to at least one embodiment. An OFDM system is used as an example for description. The distributed learning method is applied to communication between any two nodes shown in FIG. 1.

As shown in FIG. 8, the distributed learning method includes the following steps.

S801. A first node processes first data by using a first data model to obtain first intermediate data.

For example, the first node includes the first data model, and the first data model is built in the first node.

For example, the first data model is neural network software. The first data model is built in the first node in a form of neural network software or hardware, for example, a training program or an executable script of a neural network.

Optionally, the first data is data in a training sample or data during inference. S801 is applied to a training process or an inference process.

With reference to FIG. 6 or FIG. 7, the first node processes first data x based on the first data model to output first intermediate data z.

With reference to step (a) in FIG. 9A to FIG. 11B, the first data is x, and the first node processes x by using the first data model whose parameter is θ₁, to obtain z=f_{θ}_{₁}(x), where f_{θ}_{₁}( ) is a neural network model whose parameter is 01.

S802. The first node sends the first intermediate data to the second node through a first channel. Correspondingly, the second node receives second intermediate data from the first node through the first channel.

For example, the second intermediate data is a result of transmitting the first intermediate data to the second node through the first channel.

With reference to FIG. 6 or FIG. 7, the first node sends the first intermediate data z through the first channel, and after the first intermediate data z passes through the first channel, second intermediate data c is output, and the second node receives the second intermediate data c.

In some embodiments, the second node receives the first intermediate data (for example, z=f_{θ}_{₁}(x)) from the first node through the first channel (for example, g₂×Φ×g₁+h) to obtain the second intermediate data c=(g₂×Φ×g₁+h)×f_{θ}_{₁} (x)+k, where k is noise. For meanings of other symbols, refer to the foregoing descriptions of the parameter of the first channel. Details are not described herein again.

With reference to step (b) in FIG. 9A to FIG. 11B, the second node receives the first intermediate data (for example, z=f_{θ}_{₁}(x)) from the first node through the first channel (for example, h+Σₙ₌₁^{N}g_{2,n}×g_{1,n}×ϕₙ) to obtain the second intermediate data c=h+Σₙ₌₁^{N}g_{2,n}×g_{1,n}×ϕₙ)×f_{θ}_{₁}(x)+k, where k is noise, and N is a dimension of the first channel (for example, a controllable environment of the channel, a controllable part of the channel, or a trainable channel affected by the controllable part of the channel) serving as an intermediate layer. For meanings of other symbols, refer to the foregoing descriptions of the parameter of the first channel. Details are not described herein again.

For example, the first channel is updated based on the error information of the second intermediate data, the information about the first channel, and the first intermediate data.

Optionally, the error information of the second intermediate data includes a gradient of the second intermediate data or a normalized value of the gradient of the second intermediate data.

Optionally, the information about the first channel includes one or more of the following: g₁, g₂, h, and Φ.

For a specific implementation of updating the first channel, refer to S1202a and S1202b shown in FIG. 12(a), FIG. 12(b), and FIG. 12(c). Details are not described herein again.

In at least one embodiment, a channel (that is, the first channel) between the first node and the second node is trained, and the channel is used as an intermediate layer (for example, a residual layer) of a data model to participate in training and inference, so that a function, such as filtering or feature extraction, used by a DNN is implemented in a wireless transmission process, which improves performance of distributed learning. In addition, wireless transmission is enabled to directly serve for distributed learning, which reduces processing complexity and further save resources.

Optionally, a value of the parameter of the first data model is a value obtained after previous training. A value of the parameter of the first channel is a value obtained after previous training.

That is, in a forward training process or an inference process, the value of the parameter of the first data model is a value updated after previous training or an initial value (for example, the first data model is not trained), and the value of the parameter of the first channel is a value updated after previous training or an initial value (for example, the first channel is not trained).

In some embodiments, in S802, that the first node sends the first intermediate data to the second node through a first channel includes: The first node modulates the first intermediate data into a symbol, and sends the symbol to the second node through the first channel.

For example, the first node maps the first intermediate data to an air interface resource and send the first intermediate data to the second node. In this way, channel encoding and decoding are not used in a data transmission process, and resources is saved.

For example, a quantity of modulated symbols is the same as a dimension of the intermediate layer of the data model.

For example, a value of the symbol and a value of the intermediate layer satisfy the following formula: s=z or s=W×z, that is, a specific linear transformation is satisfied between the value of the symbol and the value of the intermediate layer, where s is the value of the symbol, z is the value of the intermediate layer, and W is a linear transformation matrix. This corresponds to a case in which the data model is a complex data model, that is, the neural network is a complex neural network. The following uses s=z as an example for description.

With reference to FIG. 6 or FIG. 7, in response to the dimension of the intermediate layer of the data model being 4, the quantity of symbols is also 4.

For another example, the quantity of modulated symbols is a half of the dimension of the intermediate layer of the data model. In other words, outputs of two neurons form a complex symbol, or a specific linear transformation is satisfied between the value of the symbol and the value of the intermediate layer.

For example, the following formula is satisfied between the value of the symbol and the value of the intermediate layer: sᵢ=zᵢ_{₁}+1×j×zᵢ_{₂}, where sᵢ is a value of a symbol i, i₁ and i₂ represent the i₁^{th} element and the i₂^{th} element in the intermediate layer, j is a constant, and j²=−1.

In some embodiments, that the second node receives second intermediate data from the first node through the first channel in S802 includes: The second node performs dimension matching on a symbol of the received second intermediate data.

In this way, the second node does not need to perform decoding in a process of receiving data, which saves resources.

Optionally, the second node performs dimension matching depending on whether the data model is a complex data model.

For example, a quantity of demodulated symbols is the same as a dimension of the intermediate layer of the data model. This corresponds to a case in which the data model is a complex data model.

For another example, one complex symbol of the second intermediate data is expanded into two real numbers. This corresponds to a case in which the data model is a real data model.

A specific implementation in which the second node performs dimension matching depending on whether the data model is a complex data model is similar to a corresponding implementation in which the first node modulates the first intermediate data into a symbol and sends the symbol to the second node through the first channel, and details are not described herein again.

The second node performs dimension matching on a symbol of the received second intermediate data is performed before a second data model of the second node processes the second intermediate data, for example, performed before S803.

S803. The second node processes the second intermediate data by using the second data model to obtain output data.

For example, the second node includes the second data model. Similar to the first data model, the second data model is built in the second node.

For example, the second data model is neural network software and built in the second node in a form of neural network software or hardware, for example, a training program or an executable script of a neural network.

In some embodiments, the second node processes the second intermediate data c=c=(g₂×Φ×g₁+h)×f_{θ}_{₁} (x)+k by using the second data model whose parameter is θ₂ to obtain the output data y=f_{θ}_{₂} ((g₂×Φ×g₁+h)×f_{θ1}(x)+k), where fe_{θ}_{₂}( ) is a neural network model whose parameter is θ₂, and k is noise. For meanings of other symbols, refer to the foregoing descriptions of the parameter of the first channel. Details are not described herein again.

With reference to step \textcircled{C} in FIG. 9A to FIG. 11B, using an antenna of the second node as an example, the second node processes the second intermediate data c=h+Σₙ₌₁^{N}g_{2,n}×g_{1,n}×ϕₙ)×f_{θ}_{₁} (x)+k by using the second data model whose parameter is θ₂, and the obtained output data is y=f_{θ}_{₂} ((g₂×Φ×g₁+h)×f_{θ1}(x)+k), where N is a dimension of the first channel (for example, a controllable environment of the channel, a controllable part of the channel, or a trainable channel affected by the controllable part of the channel) serving as an intermediate layer, where N is an integer greater than 0.

In some embodiments, M antennas of the second node process the second intermediate data cₘ=(hₘ+Σₙ₌₁^{N}g_{2,n,m}×g_{1,n}×ϕ_{1,n})×f_{θ}_{₁} (x)+kₘ by using the second data model whose parameter is θ₂, and the obtained output data is y=f_{θ}_{₂} (c₁, c₂, . . . , cₘ, . . . , c_{M}), where N is a dimension of the channel (for example, a controllable environment of the channel, a controllable part of the channel, or a trainable channel affected by the controllable part of the channel) serving as an intermediate layer, where N is an integer greater than 0, and M is a quantity of antennas included in the second node, where m is an integer greater than or equal to 1.

Optionally, a value of the parameter θ₂ of the second data model of the second node is a value updated after previous training.

That is, in a forward training process or an inference process, the value of the parameter of the second data model is a value updated after previous training or an initial value (for example, the second data model is not trained).

By using the foregoing distributed learning method, a channel is combined with a data model, the first channel for transmitting data between the first node and the second node is used as an intermediate layer of the data model, and the first channel is trained. The first channel is optimized based on the error information of the second intermediate data, the information about the first channel, and the first intermediate data, which improves performance of distributed learning. In addition, wireless transmission is enabled to directly serve for distributed learning, to implement integration of communication and computing, which reduces processing complexity and further save resources.

S801 to S803 is a forward training process or an inference process. Optionally, in an inference process, the second node feeds back the obtained output data to the first node.

Optionally, the second node determines a loss function based on an output result.

For example, the loss function is expressed as the following formula: L=error(y, y_{label}), where y_{label} is a label corresponding to first data x, y is an output result, error is a loss function, and error is related to a task of a distributed DNN. For example, in correspondence with a classification task, error is cross-entropy; and in correspondence with a regression task, error is a mean square error.

In at least one embodiment, the distributed learning method provided in at least one embodiment further includes a reverse training process, as shown in FIG. 12(a), FIG. 12(b), and FIG. 12(c), including S1201, S1202a, S1202b, and S1203 to S1207. The distributed learning method shown in FIG. 12(a), FIG. 12(b), and FIG. 12(c) is used in combination with the distributed learning method shown in FIG. 8.

S1201. A second node update a second data model based on output data to obtain a new second data model.

In some embodiments, S1201 includes the following step 1 and step 2.

Step 1: The second node obtains an updated value of a parameter of the second data model.

Optionally, the second node obtains the updated value of the parameter of the second data model by using error information of the parameter of the second data model. For example, the error information includes a gradient or a normalized value of the gradient.

For example, the error information of the parameter of the second data model is determined by the second node based on the second intermediate data and a loss function.

With reference to step (d) in FIG. 9A to FIG. 11B, using an example in which the error information is a gradient, the second node determines, based on the second intermediate data (for example, c=(h+Σₙ₌₁^{N}g_{2,n}×g_{2,n}×ϕ_{1,n})×f_{θ}_{₁}(x)+k) and a loss function L, that the gradient of the parameter θ₂ of the second data model is

$$\frac{\partial L}{\partial {θ}_{2}} = \frac{\partial L}{\partial y} \times \frac{\partial y}{\partial {θ}_{2}} = \frac{\partial L}{\partial y} \times {f}_{{θ}_{2}}^{′} ( ( h + {\sum }_{n = 1}^{N} {g}_{2 , n} \times {g}_{1 , n} \times {ϕ}_{n} ) \times {f}_{{θ}_{1}} ( x ) + k ) = \frac{\partial L}{\partial y} \times {f}_{{θ}_{2}}^{′} ( c ) ,$$

and then, the updated value of the parameter θ₂ is

$${θ}_{2}^{′} = {θ}_{2} - η \times \frac{\partial L}{\partial {θ}_{2}} = {θ}_{2} - η \times \frac{\partial L}{\partial y} \times \frac{\partial y}{\partial {θ}_{2}} = {θ}_{2} - η \times \frac{\partial L}{\partial y} \times {f}_{{θ}_{2}}^{′} ( c ) ,$$

where
L is a loss function, y is output data, η is a learning rate, θ₂′ is the updated value of the parameter θ₂, and θ₂ is a current value of the parameter of the second data model. For example, θ₂ is a value obtained after previous training.

Step 2: The second node updates the second data model based on the updated value of the parameter of the second data model.

For example, the second node updates the second data model by using θ₂′. For example, the value of the parameter of the second data model is set to

$${θ}_{2} - η \times \frac{\partial ℒ}{\partial y} \times \frac{\partial y}{\partial {θ}_{2}} .$$

S1202a and S1202b are steps of updating the first channel. Optionally, the first channel is updated by the first node (S1202a) or the second node (S1202b).

S1202a. The first node obtains a new first channel based on error information of the second intermediate data, information about the first channel, and first intermediate data.

Optionally, the first channel includes a second channel and a third channel. S1202a includes: The first node updates the second channel based on the error information of the second intermediate data, information about the third channel, and the first intermediate data.

S1202b. The second node obtains a new first channel based on error information of second intermediate data, information about the first channel, and first intermediate data.

Optionally, the first channel includes a second channel and a third channel. S1202b includes: The second node updates the second channel based on the error information of the second intermediate data, information about the third channel, and the first intermediate data.

Optionally, the first channel is updated by the first node or the second node.

For a specific implementation of the information about the first channel, refer to the foregoing description of the information about the first channel with reference to FIG. 6 and FIG. 7. Details are not described herein again.

In at least one embodiment, the distributed learning method further includes: The second node sends the error information of the second intermediate data and the information about the third channel to the first node. Correspondingly, the first node obtains the error information of the second intermediate data and the information about the third channel to the first node.

In some embodiments, that the second node sends the error information of the second intermediate data and the information about the third channel to the first node includes S1204 shown in (a) in FIG. 12: The second node sends first information to the first node. Correspondingly, that the first node obtains the error information of the second intermediate data and the information about the third channel to the first node includes: The first node receives the first information sent by the second node.

Optionally, the first information is determined by the second node based on the error information of the second intermediate data and the information about the third channel.

For example, with reference to step (e) in FIG. 9A to FIG. 11B, the second node determines, based on the output data y, a loss function, and the second intermediate data c, that the error information of the second intermediate data is

$$\frac{\partial ℒ}{\partial y} \times \frac{\partial y}{\partial c} .$$

For example, with reference to step (f) in FIG. 9A and FIG. 9B, the error information of the second intermediate data is

$$\frac{\partial ℒ}{\partial y} \times \frac{\partial y}{\partial c} ,$$

the information about the third channel is g_{2,n}×g_{1,n}, and the first information determined by the second node based on the error information of the second intermediate data and the information about the third channel is

$$\frac{\partial ℒ}{\partial y} \times \frac{\partial y}{\partial c} \times {g}_{2 , n} \times {g}_{1 , n} .$$

Referring to step (g) in FIG. FIG. 9A and FIG. 9B, the second node sends the first information

$$\frac{\partial ℒ}{\partial y} \times \frac{\partial y}{\partial c} \times {g}_{2 , n} \times {g}_{1 , n}$$

to the first node.

Optionally, the first node receives, through a fourth channel, the first information sent by the second node. Correspondingly, the second node sends the first information to the first node through the fourth channel.

For example, the fourth channel is a channel between the first node and the second node in a reverse training process. For example, the fourth channel is a control channel.

That is, a channel between the first node and the second node in a reverse training process is different from a channel between the first node and the second node in a forward training process, for example, in terms of frequency points or transmission mechanisms.

Optionally, the channel between the first node and the second node in the reverse training process is the same as the channel between the first node and the second node in the forward training process.

For example, the first information is transmitted on a conventional data/control channel, or is transmitted on another physical/logical channel dedicated to DNN training. A transmission process includes operations of reducing a data amount such as sparseness, quantization, and/or entropy coding, or includes operations of reducing a transmission error such as channel coding.

Optionally, the second node separately sends the error information of the second intermediate data and the information about the third channel to the first node. For example, the second node sends the error information of the second intermediate data to the first node, and the second node sends the information about the third channel to the first node. A sequence is not limited. Correspondingly, the first node receives the error information of the second intermediate data from the second node, and the first node receives the information of the third channel from the second node.

In at least one embodiment, in response to the channel between the first node and the second node in the reverse training process being different from the channel between the first node and the second node in the forward training process, the channel between the first node and the second node in the forward training process is referred to as the first channel, and the channel between the first node and the second node in the reverse training process is referred to as the fourth channel. In response to the channel between the first node and the second node in the reverse training process being the same as the channel between the first node and the second node in the forward training process, the channel between the first node and the second node in both the forward process and the reverse process is referred to as the first channel.

In some other embodiments, that the second node sends the error information of the second intermediate data and the information about the third channel to the first node includes S1205 shown in FIG. 12(b): The second node sends a fourth signal to the first node through the first channel.

Correspondingly, in S1205, the first node receives a third signal from the second node through the first channel.

Optionally, the fourth signal includes a signal generated by mapping the error information of the second intermediate data to an air interface resource.

For example, the second node sends the fourth signal including the error information

$$\frac{\partial ℒ}{\partial y} \times \frac{\partial y}{\partial c}$$

of the second intermediate data, and sets a parameter ϕ of the controllable part.

For example, the second node repeatedly sends the fourth signal, and adjust the parameter ϕ of the controllable part each time the fourth signal is sent.

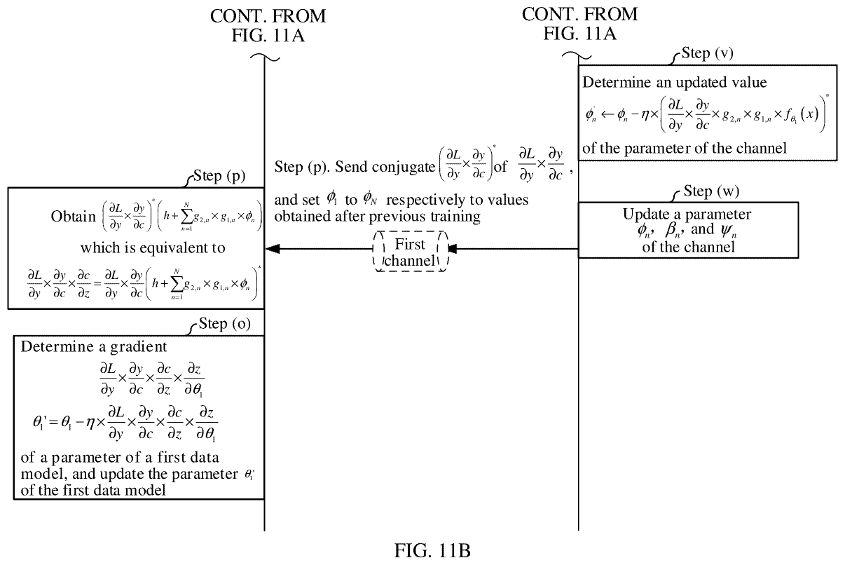

For example, with reference to step (x) in FIG. 10A and FIG. 10B, in response to sending the fourth signal including

$$\frac{\partial ℒ}{\partial y} \times \frac{\partial y}{\partial c}$$

for the first time, the second node sets ϕ₁ to ϕP_{N} to [0, 0, . . . , 0] respectively. Then, in response to the fourth signal being sent for the second time to the (N+1)^{th} time, values ofϕ₁ to ϕ_{N} are sequentially adjusted. For example, ϕ₁ to ϕ_{N} are set to

$$[ 0 , … , {\underbrace{1}}_{n} , … , 0 ]$$

respectively, that is, one parameter in ϕ₁ to ϕ_{N} is set to 1, and others are set to 0. For example, in response to the fourth signal being sent for the second time, ϕ₁ to ϕ_{N} are set to

$$[ {\underbrace{1}}_{1} , … , 0 , … , 0 ]$$

respectively, that is, ϕ₁=1 is set, and ϕ₂ to ϕ_{N} are all set to 0. Similarly, in response to the fourth signal being sent for the (N+1)^{th} time, ϕ₁ to ϕ_{N} are set to

$$[ 0 , … , 0 , … , {\underbrace{1}}_{N} ]$$

respectively.

A sequence of adjusting the parameter ϕ of the controllable part is not limited in at least one embodiment, where the foregoing is merely an example of at least one embodiment for ease of description, provided that the first node obtains the error information of the first intermediate data based on the third signal.

Correspondingly, in some other embodiments, that the first node obtains the error information of the second intermediate data and the information about the third channel includes: The first node receives a third signal from the second node through the first channel, and the first node obtains the first information based on the third signal.

Optionally, the third signal is a signal obtained after the fourth signal is transmitted to the first node through the first channel.

For example, with reference to step (x) in FIG. 10A and FIG. 10B, the third signal received by the first node includes

$$\frac{\partial L}{\partial y} \times \frac{\partial y}{\partial c} \times h or \frac{\partial L}{\partial y} \times \frac{\partial y}{\partial c} \times ( h + {g}_{2 , n \times } {g}_{1 , n} ) .$$

Optionally, the first information is determined by the first node based on the error information of the second intermediate data and the information about the third channel.

For example, with reference to step (x) in FIG. 10A and FIG. 10B, the first node obtains the first information

$$\frac{\partial L}{\partial y} \times \frac{\partial y}{\partial c} \times {g}_{2 , n} \times {g}_{1 , n}$$

based on

$$\frac{\partial L}{\partial y} \times \frac{\partial y}{\partial c} \times h$$

and

$$\frac{\partial L}{\partial y} \times \frac{\partial y}{\partial c} \times ( h + {g}_{2 , n} \times {g}_{1 , n} ) .$$

In this way, based on channel reciprocity, by using the propagation characteristic of a signal on an air interface resource, the first information (that is, the error information of the second intermediate data and the information about the third channel) is obtained through over-the-air computation, to avoid channel estimation, which reduces pilot overheads.

In at least one embodiment, the distributed learning method provided in at least one embodiment further includes S1206 shown in FIG. 12(c): The first node sends a fifth signal to the second node through the first channel. Correspondingly, the second node receives a sixth signal from the first node through the first channel.

Optionally, the fifth signal includes a signal generated by mapping third intermediate data to an air interface resource, and the third intermediate data is for updating the first channel.

For example, the third intermediate data is a result of processing the first data by the first node. The first node sends a fifth signal including the third intermediate data f_{θ}_{₁}(x), and sets a parameter ϕ of the controllable part.

For example, the first node repeatedly sends the fifth signal, and adjust the parameter ϕ of the controllable part each time the fifth signal is sent.

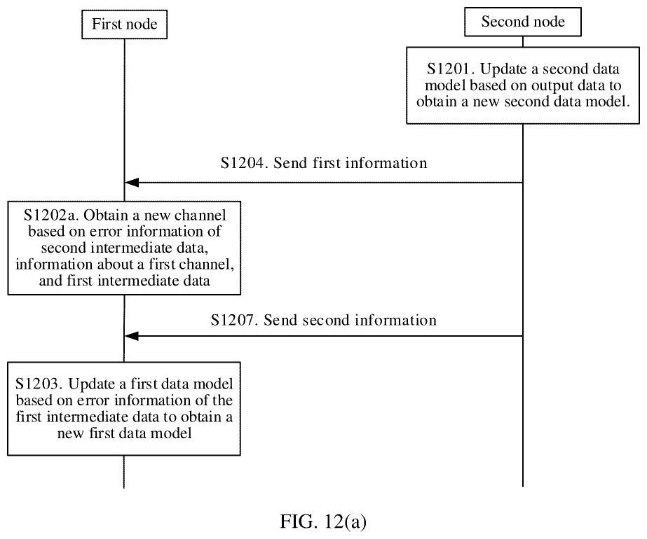

For example, with reference to step (y) in FIG. 11A and FIG. 11B, in response to sending the fifth signal including f_{θ}_{₁}(x) for the first time, the first node sets ϕ₁ to ϕ_{N} to [0, 0, . . . , 0] respectively. Then, in response to the fourth signal being sent for the second time to the (N+1)^{th} time, values of ϕ₁ to ϕ_{N} are sequentially adjusted. For example, ϕ₁ to ϕ_{N} are set to

$$[ 0 , … , {\underbrace{1}}_{n} , … , 0 ]$$

respectively, that is, one parameter in ϕ₁ to ϕ_{N} is set to 1, and others are set to 0. For example, in response to the fourth signal being sent for the second time, ϕ₁ to ϕ_{N} are set to

$$[ {\underbrace{1}}_{1} , … , 0 , … , 0 ]$$

respectively, that is, ϕ₁=1 is set, and ϕ₂ to ϕ_{N} are all set to 0. Similarly, in response to the fourth signal being sent for the (N+1)^{th} time, ϕ₁ to ϕ_{N} are set to

$$[ 0 , … , 0 , … , {\underbrace{1}}_{N} ]$$

respectively.

A sequence of adjusting the parameter ϕ of the controllable part is not limited in at least one embodiment, where the foregoing is merely an example of at least one embodiment for ease of description.

Optionally, the sixth signal is a signal obtained after the fifth signal is transmitted to the second node through the first channel.

Optionally, the first node obtains third information based on the sixth signal.

For example, the third information is determined based on the third intermediate data and the information about the third channel.

For example, with reference to step (y) in FIG. 11A and FIG. 11B, the sixth signal received by the second node includes h×f_{θ}_{₁}(x) or (h+g_{2,n}×g_{1,n})×f_{θ}_{₁}(x). The second node obtains the third information g_{2,n}×g_{1,n}×f_{θ}_{₁}(x) based on h×f_{θ}_{₁}(x) and (h+g_{2,n}×g_{1,n})×f_{θ}_{₁}(x).

In this way, based on channel reciprocity, by using the propagation characteristic of a signal on an air interface resource, the information about the third channel and the third intermediate data are obtained through over-the-air computation, to avoid channel estimation, which reduces pilot overheads.

In some embodiments, the first node or the second node obtains a new first channel based on the first information and the first intermediate data.

The following specifically describes updating the first channel (obtaining a new first channel) with reference to Example 1 to Example 4.

Example 1: A manner of updating the first channel includes the following step 1.1 to step 1.3.

Step 1.1. The first node determines error information of a parameter of the first channel based on the first information and the first intermediate data.

Optionally, the error information of the parameter of the first channel includes a gradient of the parameter of the first channel or a normalized value of the gradient of the parameter of the first channel.

For example, the parameter of the first channel is a parameter ϕ of a controllable part of the first channel. For a specific implementation of the parameter ϕ of the controllable part, refer to the foregoing description of the parameter of the first channel. Details are not described herein again.

Optionally, the first node determines error information of a parameter of the second channel based on the first information and the first intermediate data.

With reference to step (h) in FIG. 9A and FIG. 9B or FIG. 10A and FIG. 10B, the first node determines, based on the first information

$$\frac{\partial ℒ}{\partial y} \times \frac{\partial y}{\partial c} \times {g}_{2 , n} \times {g}_{1 , n}$$

and the first intermediate data f_{θ1} (x), that a gradient of the parameter of the second channel is

$$\frac{\partial ℒ}{\partial {ϕ}_{n}} = {( \frac{\partial ℒ}{\partial y} \times \frac{\partial y}{\partial c} \times {g}_{2 , n} \times {g}_{1 , n} \times {f}_{{θ}_{1}} ( x ) )}^{*} ,$$

where the symbol * is a conjugation operation.

Step 1.2. The first node determines an updated value of the parameter of the second channel based on the error information of the parameter of the second channel.

With reference to step (i) in FIG. 9A and FIG. 9B or FIG. 10A and FIG. 10B, the first node updates the parameter of the second channel by using the gradient

$${( \frac{\partial ℒ}{\partial y} \times \frac{\partial y}{\partial c} \times {g}_{2 , n} \times {g}_{1 , n} \times {f}_{{θ}_{1}} ( x ) )}^{*}$$

of the parameter ϕ of the second channel. The updated value ϕ′ₙ of the parameter of the second channel is represented by the following formula

$${ϕ}_{n}^{′} = {ϕ}_{n} - η \times {( \frac{\partial ℒ}{\partial y} \times \frac{\partial y}{\partial c} \times {g}_{2 , n} \times {g}_{1 , n} \times {f}_{{θ}_{1}} ( x ) )}^{*} ,$$

or ϕ′ₙ is represented by the following formula

$${ϕ}_{n}^{′} ← {ϕ}_{n} - η \times {( \frac{\partial ℒ}{\partial y} \times \frac{\partial y}{\partial c} \times {g}_{2 , n} \times {g}_{1 , n} \times {f}_{{θ}_{1}} ( x ) )}^{*} ,$$

where
ϕ′ₙ represents the updated value of the parameter of the second channel, and ϕₙ represents a current value of the parameter of the second channel. For example, ϕₙ is a value obtained after previous training.

Step 1.3. The first node updates the second channel based on the updated value of the parameter of the second channel.

With reference to step (j) in FIG. 9A and FIG. 9B or FIG. 10A and FIG. 10B, the first node updates the parameter ϕ₂, βₙ, and ψₙ of the second channel by using

$${η ( \frac{\partial ℒ}{\partial y} \times \frac{\partial y}{\partial c} \times {g}_{2 , n} \times {g}_{1 , n} \times {f}_{{θ}_{1}} ( x ) )}^{*} ,$$

to obtain a new first channel.

Optionally, the first node is configured to adjust the parameter of the second channel.

For example, the first node has a function of adjusting the parameter of the second channel. For example, the first node includes a controller. The controller is configured to adjust the parameter of the controllable part.

In some embodiments, after performing the foregoing step 1.1, the first node performs the following step 2.1, to enable the second node to update the first channel.

Example 2: A manner of updating the first channel includes the foregoing step 1.1 and the following step 2.1 to step 2.3. Step 1.1 is performed first, and then step 2.1 to step 2.3 are performed.

Step 2.1. The first node sends the error information of the parameter of the second channel to the second node. Correspondingly, the second node receives the error information of the parameter of the second channel from the first node.

For a specific implementation of the error information of the parameter of the second channel, refer to the foregoing step 1.1. Details are not described herein again.

With reference to step (k) in FIG. 9A and FIG. 9B, the first node sends

$${( \frac{\partial ℒ}{\partial y} \times \frac{\partial y}{\partial c} \times {g}_{2 , n \times } {g}_{1 , n} \times {f}_{{θ}_{1}} ( x ) )}^{*}$$

to the second node.

Optionally, the first node sends the error information of the parameter of the second channel to the second node through the fourth channel. Correspondingly, the second node receives the error information of the parameter of the second channel from the first node through the fourth channel.

Step 2.2. The second node determines an updated value of the parameter of the second channel based on the error information of the parameter of the second channel.

Implementation of step 2.2 is similar to that of the foregoing step 1.2, and a main difference is that the first node is replaced with the second node, and details are not described herein again.

Step 2.3. The second node updates the second channel based on the updated value of the parameter of the second channel.

With reference to step (1) in FIG. 9A and FIG. 9B, the second node updates the parameter ϕₙ, βₙ, and ψₙ of the second channel by using

$${ϕ}_{n} - η \times {( \frac{\partial ℒ}{\partial y} \times \frac{\partial y}{\partial c} \times {g}_{2 , n} \times {g}_{1 , n} \times {f}_{{θ}_{1}} ( x ) )}^{*} ,$$

to obtain a new first channel.

For example, the second node has a function of adjusting the parameter of the second channel. For example, the second node includes a controller. The controller is configured to adjust the parameter of the controllable part.

In this way, in response to the first node not having a function of adjusting the parameter of the second channel, and the second node has a function of adjusting the parameter of the second channel, the first node sends the error information of the parameter of the second channel to the second node, to enable the second node to update the first channel.

In some embodiments, after performing the foregoing step 1.2, the first node performs the following step 3.1 without performing step 1.3, to enable the second node to update the second channel.

Example 3: A manner of updating the second channel includes the foregoing step 1.1 and step 1.2 and the following step 3.1 and step 3.2.

Step 3.1. The first node sends the updated value of the parameter of the second channel to the second node. Correspondingly, the second node receives the updated value of the parameter of the second channel from the first node.

With reference to step (k) in FIG. 9A and FIG. 9B, the first node sends the updated value

$${ϕ}_{n} - η \times {( \frac{\partial ℒ}{\partial y} \times \frac{\partial y}{\partial c} \times {g}_{2 , n} \times {g}_{1 , n} \times {f}_{{θ}_{1}} ( x ) )}^{*}$$

of the parameter of the second channel to the second node.

Step 3.2. The second node updates the second channel based on the updated value of the parameter of the second channel.

For an implementation of step 3.2, reference is made to step 2.3. Details are not described herein again.

For example, the second node has a function of adjusting the parameter of the second channel. For example, the second node includes a controller. The controller is configured to adjust the parameter of the controllable part.

In this way, in response to the first node not having a function of adjusting the parameter of the second channel, and the second node has a function of adjusting the parameter of the second channel, the first node sends the updated value of the parameter of the second channel to the second node, to enable the second node to update the first channel.

Example 4: A manner of updating the first channel includes the following step 4.1 to step 4.3.

Step 4.1: The second node determines error information of a parameter of the second channel based on the error information of the second intermediate data, the information about the third channel, and the first intermediate data.

For example, the second node updates the second channel based on third information and the error information of the second intermediate data.

Optionally, the error information of the parameter of the second channel includes a gradient of the parameter of the second channel or a normalized value of the gradient of the parameter of the second channel.

For example, the parameter of the second channel is a parameter ϕ of a controllable part of the first channel. For a specific implementation of the parameter ϕ of the controllable part, refer to the foregoing description of the parameter of the first channel. Details are not described herein again.

Optionally, the second node determines the error information of the parameter of the second channel based on the error information of the second intermediate data, the information about the third channel, and the first intermediate data.

For example, the second node determines the error information of the parameter of the second channel based on the third information and the error information of the second intermediate data.

With reference to step (u) in FIG. 11A and FIG. 11B, the second node determines, based on the third information g_{2,n}×g_{1,n}×f_{θ}_{₁}(x) and the error information

$$\frac{\partial ℒ}{\partial y} \times \frac{\partial y}{\partial c}$$

of the second intermediate data, that the gradient of the parameter ϕ of the second channel is

$${( \frac{\partial ℒ}{\partial y} \times \frac{\partial y}{\partial c} \times {g}_{2 , n \times } {g}_{1 , n} \times {f}_{{θ}_{1}} ( x ) )}^{*} .$$

Step 4.2. The second node determines an updated value of the parameter of the second channel based on the error information of the parameter of the second channel.

With reference to step (v) in FIG. 11A and FIG. 11B, the second node updates the parameter of the second channel by using the gradient

$${( \frac{\partial ℒ}{\partial y} \times \frac{\partial y}{\partial c} \times {g}_{2 , n} \times {g}_{1 , n} \times {f}_{{θ}_{1}} ( x ) )}^{*}$$

of the parameter ϕ of the second channel. The updated value ϕ′ₙ of the parameter of the second channel is represented by the following formula

$${ϕ}_{n}^{′} = {ϕ}_{n} - η \times {( \frac{\partial ℒ}{\partial y} \times \frac{\partial y}{\partial c} \times {g}_{2 , n} \times {g}_{1 , n} \times {f}_{{θ}_{1}} ( x ) )}^{*} ,$$

or ϕ′ₙ is represented by the following formula

$${ϕ}_{n}^{′} ← {ϕ}_{n} - η \times {( \frac{\partial ℒ}{\partial y} \times \frac{\partial y}{\partial c} \times {g}_{2 , n} \times {g}_{1 , n} \times {f}_{{θ}_{1}} ( x ) )}^{*} .$$

Step 4.3. The second node updates the second channel based on the updated value of the parameter of the second channel.

With reference to step (w) in FIG. 11A and FIG. 11B, the second node updates the parameter ϕₙ, βₙ, and ψₙ of the second channel by using

$${ϕ}_{n} - η \times {( \frac{\partial ℒ}{\partial y} \times \frac{\partial y}{\partial c} \times {g}_{2 , n} \times {g}_{1 , n} \times {f}_{{θ}_{1}} ( x ) )}^{*} ,$$

to obtain a new first channel.

For example, the second node has a function of adjusting the parameter of the second channel. For example, the second node includes a controller. The controller is configured to adjust the parameter of the controllable part.

The manners of updating the first channel recorded in Example 1 to Example 4 is further applied to a case in which both the first node and the second node have a function of adjusting a parameter of a channel.

In at least one embodiment, the distributed learning method provided in at least one embodiment includes: The first node sends a first signal to the second node through the first channel. Correspondingly, the second node receives a second signal from the first node through the first channel.

For example, the second signal is a signal obtained after the first signal is transmitted to the second node through the first channel.

Optionally, the first signal is for determining the information about the third channel.

For example, the first signal is a pilot signal, and the first node sends a pilot and set a parameter ϕ of the controllable part.

For example, with reference to step (m) in FIG. 9A and FIG. 9B, the first node sends a pilot to the second node, and the first node sets ϕ₁ to ϕ₁ to [0, 0, . . . , 0] respectively, and sets ϕ₁ to ϕ_{N} to

$$[ 0 , ... , {\underbrace{1}}_{n} , ... , 0 ]$$

respectively, that is, sets one parameter in ϕ₁ to ϕ_{N} to 1, and sets others to 0. For example, in response to n=1, ϕ₁ to ϕ_{N} are set to

$$[ {\underbrace{1}}_{1} , ... , 0 , ... , 0 ]$$

respectively, that is, ϕ₁=1 is set, and ϕ₂ to ϕ_{N} are all set to 0.

Optionally, the second node obtains the information about the first channel based on the second signal.

In this way, the second node performs channel estimation to obtain information about a channel, and updates the channel or the first data model, to improve performance of distributed learning.

For example, with reference to step (n) in FIG. 9A and FIG. 9B, the first node sets ϕ₁ to ϕ_{N} to [0, 0, . . . , 0] respectively, and sends a pilot signal to the second node. Based on an expression h+Σₙ₌₁^{N}g_{2,n}×g_{1,n}×ϕₙ On of a channel, the second node obtains information h about the first channel (for example, the third channel).

The first node sets ϕ₁ to ϕ_{N} to

$$[ 0 , ... , {\underbrace{1}}_{n} , ... , 0 ]$$

respectively, that is, sets one n parameter in ϕ₁ to ϕ_{N} to 1, and sets others to 0. Based on an expression h+Σₙ₌₁^{N}g_{2,n}×g_{1,n}×ϕₙ of a channel, the second node obtains information h+g_{2,n}×g_{1,n} about the first channel (for example, the third channel). For example, in response to n=1, ϕ₁ to ϕ_{N} are set to

$$[ {\underbrace{1}}_{1} , ... , 0 , ... , 0 ]$$

respectively, that is, ϕ₁=1 is set, and ϕ₂ to ϕ_{N} are all set to 0, so that the information h+g_{2,1}×g_{1,1} about the first channel (for example, the third channel) is obtained.

Based on the obtained information h about the first channel (for example, the third channel) and the obtained information h+g_{2,n}×g_{1,n} about the first channel (for example, the third channel), the second node obtains information g_{2,n}×g_{1,n} about the first channel (for example, the third channel).

For example, in step (j) in FIG. 9A and FIG. 9B and FIG. 7, the first node sets ϕ₁ to ϕ_{N} respectively to values obtained after previous training, and the second node obtains information h+Σₙ₌₁^{N}g_{2,n}×g_{1,n}×ϕₙ about the first channel.

The value of N is equal to an actual quantity of controllable units, for example, a quantity of distributed antennas or a quantity of elements of an intelligent reflective surface. Alternatively, the value of N is less than an actual quantity of controllable units. For example, for a super-large-scale antenna array or intelligent reflective surface array, a plurality of controllable units is controlled as a group, to reduce overheads.

A sequence of step (m) to step (n) and that the second node sends the first information to the first node is not limited in at least one embodiment. For example, step (m) to step (n) is performed before the second node sends the first information to the first node. That is, after obtaining the information about the first channel (for example, the third channel) through estimation, the second node sends the first information to the first node, to update the first channel.

S1203. The first node updates the first data model based on the error information of the first intermediate data to obtain a new first data model.

In some embodiments, S1203 includes the following step 3 to step 5.

Step 3: The first node obtains the error information of the parameter of the first data model based on the error information of the first intermediate data.

With reference to step (o) in FIG. 9A to FIG. 11B, the first node obtains a gradient

$$\frac{\partial ℒ}{\partial {θ}_{1}} = \frac{\partial ℒ}{\partial y} \times \frac{\partial y}{\partial c} \times {( h + {\sum }_{n = 1}^{N} {g}_{2 , n} \times {g}_{1 , n} \times {ϕ}_{n} )}^{*} \times \frac{\partial {f}_{{θ}_{1}}}{\partial {θ}_{1}} = \frac{\partial ℒ}{\partial y} \times \frac{\partial y}{\partial c} \times \frac{\partial c}{\partial z} \times \frac{\partial z}{\partial {θ}_{1}}$$

of the parameter θ₁ of the first data model based on the error information

$$\frac{\partial ℒ}{\partial y} \times \frac{\partial y}{\partial c} \times \frac{\partial c}{\partial z}$$

of the first intermediate data.

Step 4: The first node obtains an updated value of the parameter of the first data model based on the error information of the parameter of the first data model.

With reference to step (o) in FIG. 9A to FIG. 11B, the first node obtains the updated value

$${θ}_{1}^{′} = {θ}_{1} - η \times \frac{\partial ℒ}{\partial y} \times \frac{\partial y}{\partial c} \times \frac{\partial c}{\partial z} \times \frac{\partial z}{\partial {θ}_{1}}$$

of the parameter θ₁ of the first data model based on the error information

$$\frac{\partial ℒ}{\partial y} \times \frac{\partial y}{\partial c} \times \frac{\partial c}{\partial z} \times \frac{\partial z}{\partial {θ}_{1}}$$

of the parameter of the first data model.

Step 5: The first node updates the first data model based on the updated value of the parameter of the first data model.

With reference to step (o) in FIG. 9A to FIG. 11B, the first node updates the first data model by using θ₁′. For example, the value of the parameter of the first data model is set to

$${θ}_{1} - η \frac{\partial ℒ}{\partial y} \times \frac{\partial y}{\partial c} \times \frac{\partial c}{\partial z} \times \frac{\partial z}{\partial {θ}_{1}} .$$

In at least one embodiment, the distributed learning method further includes S1207 shown in (a) in FIG. 12: The second node sends second information to the first node. Correspondingly, the first node receives the second information sent by the second node.

Optionally, the second information is for obtaining the error information of the first intermediate data.

In some embodiments, the second information includes the error information of the first intermediate data. For example, the second information includes the error information

$$\frac{\partial L}{\partial y} \times \frac{\partial y}{\partial c} \times \frac{\partial c}{\partial z}$$

of the first intermediate data.

For example, with reference to step (p) in FIG. 9A and FIG. 9B, the second node sends the error information

$$\frac{\partial L}{\partial y} \times \frac{\partial y}{\partial c} \times \frac{\partial c}{\partial z}$$

of the first intermediate data to the first node.

Optionally, the second node sends the second information to the first node through the fourth channel. Correspondingly, the first node receives, through the fourth channel, the second information sent by the second node. In other words, the second node sends the second information to the first node through the control channel.

In some embodiments, before the second node sends the second information to the first node, the distributed learning method provided in at least one embodiment further includes: The second node obtains the error information of the first intermediate data based on the error information of the second intermediate data and the information about the first channel.

For example, with reference to step (q) in FIG. 9A and FIG. 9B, the second node determines, based on the error information

$$\frac{\partial ℒ}{\partial y} \times \frac{\partial y}{\partial c}$$

of the second intermediate data and the information h+Σₙ₌₁^{N}g_{2,n}×g_{1,n}×ϕₙ about the first channel, that the error information of the first intermediate data is

$$\frac{\partial ℒ}{\partial y} \times \frac{\partial y}{\partial c} \times \frac{\partial c}{\partial z} ,$$

where

$$\frac{\partial c}{\partial z}$$

is a function of the first channel, and for a linear complex channel

$$\frac{\partial c}{\partial z} = {( h + {\sum }_{n = 1}^{N} {g}_{2 , n} \times {g}_{1 , n} \times {ϕ}_{n} )}^{*} ,$$

the symbol * is a conjugation operation.

That is, after obtaining the error information of the first intermediate data, the second node sends the second information including the error information of the first intermediate data to the first node, so that the first node updates the first data model, which improves performance of distributed learning.

In some other embodiments, the second information includes the error information of the second intermediate data and the information about the first channel, and the error information of the second intermediate data and the information about the first channel are for determining the error information of the first intermediate data.

That is, the second node sends the error information of the second intermediate data and the information about the first channel to the first node. Correspondingly, the first node receives the error information of the second intermediate data and the information about the first channel that are sent by the second node.

In at least one embodiment, the distributed learning method further includes: S1207 shown in FIG. 12(b) or FIG. 12(c): The second node sends a seventh signal to the first node. Correspondingly, the first node receives an eighth signal from the second node, and obtains the error information of the first intermediate data based on the eighth signal.

Optionally, the eighth signal is a signal obtained after a seventh signal is transmitted to the first node through the first channel, and the seventh signal includes a signal generated by mapping the error information of the second intermediate data to an air interface resource.

For example, the second node sends the error information of the second intermediate data, and set a parameter of the controllable part.

For example, the second node forms, based on dimension matching, the error information

$$\frac{\partial ℒ}{\partial y} \times \frac{\partial y}{\partial c}$$

of the second intermediate data into a modulated symbol, modulate the modulated symbol into a waveform for sending, and adjust a parameter ϕ of the controllable part, so that the first node receives different over-the-air computation results.

For example, with reference to step (p) in FIG. 10A to FIG. 11B, the second node sends a conjugate

$${( \frac{\partial ℒ}{\partial y} \times \frac{\partial y}{\partial c} )}^{*}$$

of the error information

$$\frac{\partial ℒ}{\partial y} \times \frac{\partial y}{\partial c}$$

of the second intermediate data, and sets ϕ₁ to ϕ_{N} respectively to values obtained after previous training, so that the first node obtains the second information

$${( \frac{\partial ℒ}{\partial y} \times \frac{\partial y}{\partial c} )}^{*} ( h + {\sum }_{n = 1}^{N} {g}_{2 , n} \times {g}_{1 , n \times } {ϕ}_{n} ) .$$

The error information of the first intermediate data obtained by the first node meets the following formula

$${( \frac{\partial ℒ}{\partial y} \times \frac{\partial y}{\partial c} \times \frac{\partial c}{\partial z} )}^{*} = {( \frac{\partial ℒ}{\partial y} \times \frac{\partial y}{\partial c} )}^{*} ( h + {\sum }_{n = 1}^{N} {g}_{2 , n} \times {g}_{1 , n} \times {ϕ}_{n} ) ,$$

which is equivalent to

$$\frac{\partial ℒ}{\partial y} \times \frac{\partial y}{\partial c} \times \frac{\partial c}{\partial z} = \frac{\partial ℒ}{\partial y} \times \frac{\partial y}{\partial c} {( h + {\sum }_{n = 1}^{N} {g}_{2 , n} \times {g}_{1 , n \times } {ϕ}_{n} )}^{*} .$$

In this way, over-the-air computation of the gradient of the intermediate layer of the neural network of the first node is implemented through a process of propagation of a signal in the air, which reduces pilot overheads.

Optionally, the distributed learning method provided in at least one embodiment further includes performing processing, such as normalization, amplitude limiting, sparseness, and/or power control, on the error information of the parameter of the first data model, the error information of the parameter of the channel, and the error information of the parameter of the second data model, to reduce a peak-to-average ratio of a transmit waveform, improve a signal-to-noise ratio, and so on.

A sequence of S1201 to S1208 is not limited in at least one embodiment provided that reverse training is implemented.

By using the foregoing distributed learning method, a channel between the first node and the second node is trained, the channel is used as an intermediate layer (for example, a residual layer) of a data model, and the first data model, the channel, and the second data model are trained and enabled to participate in inference, which improves performance of distributed learning. In addition, wireless transmission is enabled to directly serve for distributed learning, which reduces processing complexity and further save resources.

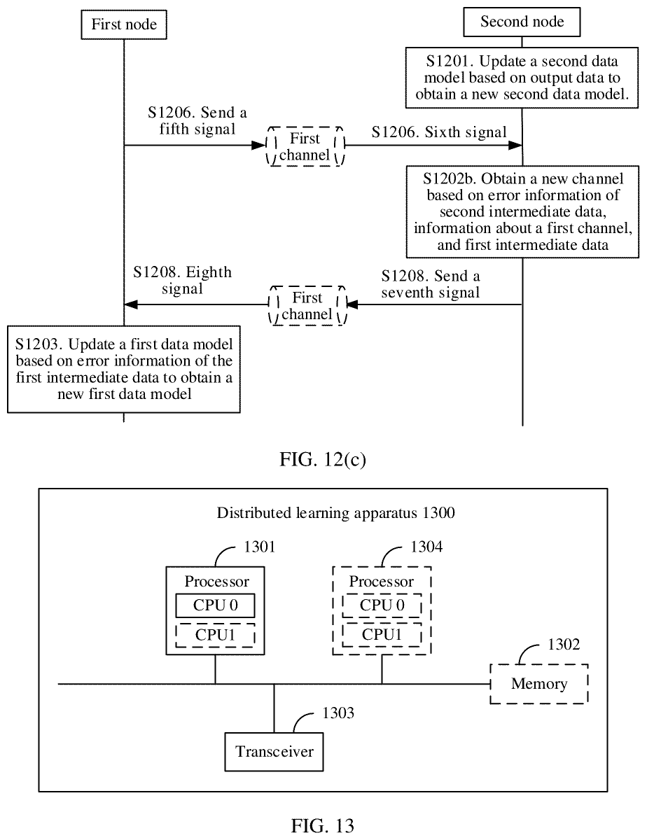

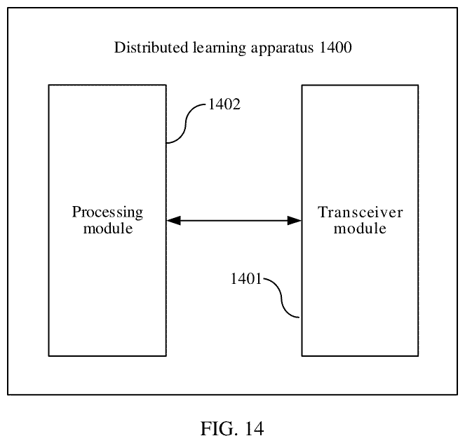

The distributed learning method provided in at least one embodiment is described in detail above with reference to FIG. 8 to FIG. 12(c). A distributed learning apparatus provided in at least one embodiment is described below in detail with reference to FIG. 13 to FIG. 14.

FIG. 13 is a schematic diagram of a structure of a distributed learning apparatus configured to perform a distributed learning method according to at least one embodiment. A distributed learning apparatus 1300 is a first node or a second node, or is a chip or another component having a corresponding function used in the first node or the second node. As shown in FIG. 13, the distributed learning apparatus 1300 includes a processor 1301 and a transceiver 1303, and further includes a memory 1302. The processor 1301 is coupled to the memory 1302 and the transceiver 1303. For example, the processor 1301 is connected to the memory 1302 and the transceiver 1303 by a communication bus. Alternatively, the processor 1301 is used independently.

The following describes in detail components of the distributed learning apparatus 1300 with reference to FIG. 13.

The processor 1301 is a control center of the distributed learning apparatus 1300, and is one processor, or is a general term of a plurality of processing elements.

The processor 1301 performs various functions of the distributed learning apparatus 1300 by running or executing a software program stored in the memory 1302 and invoking data stored in the memory 1302.

In a specific implementation, in an embodiment, the processor 1301 includes one or more CPUs, for example, a CPU 0 and a CPU 1 shown in FIG. 13.

In a specific implementation, in an embodiment, the distributed learning apparatus 1300 includes a plurality of processors, for example, a processor 1301 and a processor 1304 shown in FIG. 13. Each of the processors is a single-core processor (single-CPU) or is a multi-core processor (multi-CPU). The processor herein is one or more communication devices, circuits, and/or processing cores configured to process data (for example, computer program instructions).

The memory 1302 is integrated with the processor 1301, or exists independently, and is coupled to the processor 1301 through an input/output port (not shown in FIG. 13) of the distributed learning apparatus 1300. This is not specifically limited in at least one embodiment.

For example, the input port is configured to implement receiving functions performed by the first node or the second node in any one of the foregoing method embodiments, and the output port is configured to implement sending functions performed by the first node or the second node in any one of the foregoing method embodiments.

The memory 1302 is configured to store a software program for executing the solutions of at least one embodiment, and the processor 1301 controls execution. For a specific implementation, refer to the foregoing method embodiments. Details are not described herein again.

The transceiver 1303 is configured to communicate with another apparatus. For example, in response to the distributed learning apparatus 1300 being the first node, the transceiver 1303 is configured to communicate with the second node. For another example, in response to the distributed learning apparatus 1300 being the second node, the transceiver 1303 is configured to communicate with the first node. In addition, the transceiver 1303 includes a receiver and a transmitter (not separately shown in FIG. 13). The receiver is configured to implement a receiving function, and the transmitter is configured to implement a sending function. The transceiver 1303 is integrated with the processor 1301, or exists independently, and is coupled to the processor 1301 through an input/output port (not shown in FIG. 13) of the distributed learning apparatus 1300. This is not specifically limited in at least one embodiment.

A structure of the distributed learning apparatus 1300 shown in FIG. 13 does not constitute a limitation on the distributed learning apparatus. An actual distributed learning apparatus includes more or fewer components than those shown in the figure, or some components is combined, or a different component arrangement is used.

Actions of the first node in the foregoing steps S801, S802, S1202a, S1203, and S1206 is performed by the processor 1301 in the distributed learning apparatus 1300 shown in FIG. 13 by invoking application program code stored in the memory 1302, to indicate the first node to perform the actions.

Actions of the second node in the foregoing steps S803, S1201, S1202b, S1204, S1205, S1207, and S1208 is performed by the processor 1301 in the distributed learning apparatus 1300 shown in FIG. 13 by invoking application program code stored in the memory 1302, to indicate the second node to perform the actions. This is not limited in this embodiment.

FIG. 14 is a schematic diagram of a structure of another distributed learning apparatus according to at least one embodiment. For ease of description, FIG. 14 shows only main components of the distributed learning apparatus.

The distributed learning apparatus 1400 includes a transceiver module 1401 and a processing module 1402. The distributed learning apparatus 1400 is the first node or the second node in the foregoing method embodiments. The transceiver module 1401 is also referred to as a transceiver unit, and is configured to implement sending and receiving functions performed by the first node or the second node in any one of the foregoing method embodiments.

The transceiver module 1401 includes a receiving module and a sending module (not shown in FIG. 14). The receiving module is configured to receive data and/or signaling from a first node. The sending module is configured to send data and/or signaling to the first node. A specific implementation of the transceiver module is not specifically limited in at least one embodiment. The transceiver module includes a transceiver circuit, a transceiver machine, a transceiver, or a communication interface.

The processing module 1402 is configured to implement a processing function performed by the first node or the second node in any one of the foregoing method embodiments. The processing module 1402 is a processor.

In this embodiment, the distributed learning apparatus 1400 is presented in a form of dividing function modules in an integrated manner. The “module” herein is a specific ASIC, a circuit, a processor that executes one or more software or firmware programs, a memory, an integrated logic circuit, and/or another component that provides the foregoing functions. In an embodiment, a person skilled in the art is able to figure out that the distributed learning apparatus 1400 is in a form of the distributed learning apparatus 1300 shown in FIG. 13.

For example, the processor 1301 in the distributed learning apparatus 1300 shown in FIG. 13 invokes computer-executable instructions stored in the memory 1302, so that the distributed learning method in the foregoing method embodiment is performed.

Specifically, functions/implementation processes of the transceiver module 1401 and the processing module 1402 in FIG. 14 is implemented by the processor 1301 in the distributed learning apparatus 1300 shown in FIG. 13 by invoking computer-executable instructions stored in the memory 1302. Alternatively, functions/implementation processes of the processing module 1402 in FIG. 14 is implemented by the processor 1301 in the distributed learning apparatus 1300 shown in FIG. 13 by invoking computer-executable instructions stored in the memory 1302, and functions/implementation processes of the transceiver module 1401 in FIG. 14 is implemented by the transceiver 1303 in the distributed learning apparatus 1300 shown in FIG. 13.

Because the distributed learning apparatus 1400 provided in this embodiment performs the foregoing distributed learning method, for technical effects that is obtained by the distributed learning apparatus 1400, refer to the foregoing method embodiments. Details are not described herein again.

In at least one embodiment, the distributed learning apparatus 1400 shown in FIG. 14 is used in the communication system shown in FIG. 1, and perform functions of the first node in the distributed learning method shown in FIG. 8 and/or FIG. 12(a), FIG. 12(b), and FIG. 12(c).

The processing module 1402 is configured to process first data by using the first data model to obtain first intermediate data.

The transceiver module 1401 is configured to send the first intermediate data to a second node through a first channel, where the first channel is updated based on error information of second intermediate data, information about the first channel, and the first intermediate data, the second intermediate data is a result of transmitting the first intermediate data to the second node through the first channel, and the first channel is a channel between the distributed learning apparatus and the second node.

Optionally, the distributed learning apparatus 1400 further includes a storage module (not shown in FIG. 14), and the storage module stores a program or instructions. In response to the processing module 1402 executing the program or the instructions, the distributed learning apparatus 1400 is enabled to perform functions of the first node in the distributed learning method shown in FIG. 3.

The distributed learning apparatus 1400 is a first node, or is, for example, a chip (system) or another component or assembly that is arranged in the first node. This is not limited in at least one embodiment.

In addition, for technical effects of the distributed learning apparatus 1400, refer to the technical effects of the distributed learning methods shown in FIG. 8, FIG. 12(a), FIG. 12(b), and FIG. 12(c). Details are not described herein again.

In at least one embodiment, the distributed learning apparatus 1400 shown in FIG. 14 is used in the communication system shown in FIG. 1, and perform functions of the second node in the distributed learning method shown in FIG. 8 and/or FIG. 12(a), FIG. 12(b), and FIG. 12(c).

The transceiver module 1401 is configured to receive second intermediate data through a first channel, where the second intermediate data is a result of transmitting first intermediate data sent by a first node to the distributed learning apparatus through the first channel, the first channel is updated based on error information of the second intermediate data, information about the first channel, and the first intermediate data, and the first channel is a channel between the first node and the distributed learning apparatus.

The processing module 1402 is configured to process the second intermediate data by using the second data model to obtain output data.

Optionally, the distributed learning apparatus 1400 further includes a storage module (not shown in FIG. 14), and the storage module stores a program or instructions. In response to the processing module 1402 executing the program or the instructions, the distributed learning apparatus 1400 is enabled to perform functions of the second node in the distributed learning method shown in FIG. 8, FIG. 12(a), FIG. 12(b), and FIG. 12(c).

The distributed learning apparatus 1400 is a second node, or is, for example, a chip (system) or another component or assembly that is arranged in the second node. This is not limited in at least one embodiment.

In addition, for technical effects of the distributed learning apparatus 1400, refer to the technical effects of the distributed learning methods shown in FIG. 8, FIG. 12(a), FIG. 12(b), and FIG. 12(c). Details are not described herein again.

At least one embodiment provides a communication system. The communication system includes a first node and a second node.

The first node is configured to perform actions of the first node in the foregoing method embodiments. For specific execution methods and processes, refer to the foregoing method embodiments. Details are not described herein again.

The second node is configured to perform actions of the second node in the foregoing method embodiments. For specific execution methods and processes, refer to the foregoing method embodiments. Details are not described herein again.

At least one embodiment provides a chip system. The chip system includes a processor and an input/output port. The processor is configured to implement processing functions included in the distributed learning method provided in at least one embodiment, and the input/output port is configured to perform sending and receiving functions included in the distributed learning method provided in at least one embodiment.

For example, the input port is configured to implement receiving functions included in the distributed learning method provided in at least one embodiment, and the output port is configured to implement sending functions included the distributed learning method provided in at least one embodiment.

In at least one embodiment, the chip system further includes a memory, and the memory is configured to store program instructions and data for implementing the functions included in the distributed learning method provided in at least one embodiment.

The chip system includes a chip, or includes a chip and another discrete component.

At least one embodiment provides a computer-readable storage medium. The computer-readable storage medium includes a computer program or instructions. In response to the computer program or the instructions being run on a computer, the distributed learning method provided in at least one embodiment is performed.

At least one embodiment provides a computer program product. The computer program product includes a computer program or instructions. In response to the computer program or the instructions being run on a computer, the distributed learning method provided in at least one embodiment is performed.

The processor in at least one embodiment is a central processing unit (CPU). Alternatively, the processor is another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general purpose processor is a microprocessor, or the processor is any conventional processor or the like.

The memory in at least one embodiment is a volatile memory or a nonvolatile memory, or includes a volatile memory and a nonvolatile memory. The nonvolatile memory is a read-only memory (ROM), a programmable read-only memory (PROM), an erasable programmable read-only memory (EPROM), an electrically erasable programmable read-only memory (EEPROM), or a flash memory. The volatile memory is a random access memory (RAM), and is used as an external cache. By way of illustrative rather than limitative descriptions, random access memories (RAMs) in many forms is used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

The foregoing embodiments is fully or partly implemented through software, hardware (such as a circuit), firmware, or any combination thereof. In response to software being used to implement embodiments, all or some of the foregoing embodiments is implemented in a form of a computer program product. The computer program product includes one or more computer instructions or computer programs. In response to the computer instructions or the computer programs being loaded or executed on a computer, the procedure or functions according to at least one embodiment are all or partially generated. The computer is a general-purpose computer, a dedicated computer, a computer network, or other programmable apparatuses. The computer instructions is stored on a computer-readable storage medium, or transmitted from one computer-readable storage medium to another computer-readable storage medium. For example, the computer instructions is transmitted from a website, computer, server, or data center to another website, computer, server, or data center in a wired (for example, infrared, radio, or microwave) manner. The computer-readable storage medium is any usable medium accessible to a computer, or a data storage device, such as a server or a data center, integrating one or more usable media. The usable medium is a magnetic medium (for example, a floppy disk, a hard disk, or a magnetic tape), an optical medium (for example, DVD), a semiconductor medium, or the like. The semiconductor medium is a solid state drive.

The term “and/or” in embodiments described herein is only an association relationship between associated objects and represents that three relationships exists. For example, A and/or B represents the following three cases: Only A exists, both A and B exist, and only B exists. A and B is singular or plural. In addition, the character “/” in at least one embodiment usually indicates an “or” relationship between the associated objects, but also indicates an “and/or” relationship. For details, refer to the context for understanding.

In at least one embodiment, at least one means one or more, and a plurality of means two or more. At least one of the following items (pieces) or a similar expression thereof refers to any combination of these items, including any combination of singular items (pieces) or plural items (pieces). For example, at least one of a, b, or c indicates: a, b, c, a-b, a-c, b-c, or a-b-c, where a, b, and c is singular or plural.

Sequence numbers of the foregoing processes do not mean execution sequences in at least one embodiment. The execution sequences of the processes should be determined based on functions and internal logic of the processes, and should not be construed as any limitation on the implementation processes of embodiments described herein.

A person of ordinary skill in the art is aware that, in combination with the examples described in embodiments herein, units and algorithm steps is implemented by electronic hardware or a combination of computer software and electronic hardware. Whether the functions are performed by hardware or software depends on particular applications and design constraints of the technical solutions. A person skilled in the art is able to use different methods to implement the described functions of each particular application, but the implementation does not go beyond the scope of embodiments described herein.

A person skilled in the art that understands that, for convenient and brief description, for a detailed working process of the foregoing system, apparatus, and units, refer to a corresponding process in the foregoing method embodiments, and details are not described herein again.

At least one embodiment is to be understood that the disclosed systems, apparatuses, and methods is implemented in other manners. For example, the described apparatus embodiment is merely an example. For example, division into the units is merely logical function division and is other division during actual implementation. For example, a plurality of units or components is combined or integrated into another system, or some features is ignored or not performed. In addition, the displayed or discussed mutual couplings or direct couplings or communication connections is implemented through some interfaces. The indirect couplings or communication connections between the apparatuses or units is implemented in electronic, mechanical, or other forms.

The units described as separate parts may or may not be physically separate, and parts displayed as units may or may not be physical units, is located in one position, or is distributed on a plurality of network units. Some or all of the units is selected based on actual usage to achieve the objectives of the solutions of the embodiments.

In addition, functional units in at least one embodiment is integrated into one processing unit, or each of the units exists alone physically, or two or more units are integrated into one unit.

In response to the functions being implemented in the form of a software functional unit and sold or used as an independent product, the functions is stored in a computer-readable storage medium. Based on such an understanding, the technical solutions of at least one embodiment essentially, or the part contributing to the conventional technology, or some of the technical solutions is implemented in a form of a software product. The computer software product is stored in a storage medium, and includes several instructions for indicating a computer device (which is a personal computer, a server, a second node, or the like) to perform all or some of the steps in the methods described in at least one embodiment. The foregoing storage medium includes any medium that stores program code, for example, a USB flash drive, a removable hard disk, a read-only memory (read-only memory, ROM), a random access memory (random access memory, RAM), a magnetic disk, or an optical disc.

The foregoing descriptions are merely specific implementations of at least one embodiment, but are not intended to limit the protection scope of embodiments described herein. Any variation or replacement readily figured out by a person skilled in the art within the technical scope disclosed in embodiments herein shall fall within the protection scope of at least one embodiment. Therefore, the protection scope of embodiments described herein shall be subject to the protection scope of the claims.

1. A distributed learning method, applied to a first node, wherein the first node comprises a first data model, and the method comprises:
processing first data using the first data model to obtain first intermediate data; and
sending the first intermediate data to a second node through a first channel, wherein the first channel is updated based on error information of second intermediate data, information about the first channel, and the first intermediate data, the second intermediate data is a result of transmitting the first intermediate data to the second node through the first channel, and the first channel is a channel between the first node and the second node.

2. The distributed learning method according to claim 1, wherein
the sending the first intermediate data to the second node through a first channel includes sending the first intermediate data to the second node through the first channel that includes a second channel and a third channel, and the method further comprises:
updating the second channel based on the error information of the second intermediate data, information about the third channel, and the first intermediate data.

3. The distributed learning method according to claim 2, wherein
the updating the second channel based on the error information of the second intermediate data, information about the third channel, and the first intermediate data includes:
receiving first information sent by the second node, wherein the first information is determined based on the error information of the second intermediate data and the information about the third channel; and
updating the second channel based on the first information and the first intermediate data.

4. The distributed learning method according to claim 2, wherein the updating the second channel based on the error information of the second intermediate data, information about the third channel, and the first intermediate data includes:
receiving a third signal from the second node through the first channel, wherein the third signal is a signal obtained after a fourth signal is transmitted to the first node through the first channel, and the fourth signal includes a signal generated by mapping the error information of the second intermediate data to an air interface resource;
obtaining first information based on the third signal, wherein the first information is determined based on the error information of the second intermediate data and the information about the third channel; and
updating the second channel based on the first information and the first intermediate data.

5. The distributed learning method according to claim 1, wherein the method further comprises:
sending a fifth signal to the second node through the first channel, wherein the fifth signal includes a signal generated by mapping third intermediate data to an air interface resource, and the third intermediate data is for updating the first channel.

6. The distributed learning method according to claim 1, wherein the method further comprises:
updating the first data model based on error information of the first intermediate data to obtain a new first data model.

7. The distributed learning method according to claim 6, wherein the method further comprises:
receiving second information sent by the second node, wherein the second information is used to obtain the error information of the first intermediate data;
wherein the second information includes the error information of the first intermediate data; or
the second information includes the error information of the second intermediate data and the information about the first channel, and the error information of the second intermediate data and the information about the first channel is used to determine the error information of the first intermediate data.

8. A distributed learning method, applied to a second node, wherein the second node includes a second data model, and the method comprises:
receiving second intermediate data through a first channel, wherein the second intermediate data is a result of transmitting first intermediate data sent by a first node to the second node through the first channel, the first channel is updated based on error information of the second intermediate data, information about the first channel, and the first intermediate data, and the first channel is a channel between the first node and the second node; and
processing the second intermediate data using the second data model to obtain output data.

9. The method according to claim 9, wherein the receiving the second intermediate data through the first channel includes receiving the second intermediate data through the first channel that includes a second channel and a third channel, and the method further comprises:
sending the error information of the second intermediate data and information about the third channel to the first node.

10. The distributed learning method according to claim 9, wherein
the sending the error information of the second intermediate data and information about the third channel to the first node includes:
sending first information to the first node, wherein the first information is determined based on the error information of the second intermediate data and the information about the third channel; or
sending a fourth signal to the first node through the first channel, wherein the fourth signal includes a signal generated by mapping the error information of the second intermediate data to an air interface resource.

11. The distributed learning method according to claim 8, wherein the method further comprises:
receiving a second signal from the first node through the first channel, wherein the second signal is a signal obtained after a first signal is transmitted to the second node through the first channel, and the first signal is used to determine the information about the first channel; and
obtaining the information about the first channel based on the second signal.

12. The distributed learning method according to claim 8, wherein the method further comprises:
sending second information to the first node, wherein the second information is used to obtain error information of the first intermediate data, wherein the second information includes the error information of the first intermediate data; or
the second information includes the error information of the second intermediate data and the information about the first channel, and the error information of the second intermediate data and the information about the first channel is used to determine the error information of the first intermediate data.

13. The distributed learning method according to claim 8, wherein the method further comprises:
updating the second data model based on the output data to obtain a new second data model.

14. A distributed learning apparatus, comprising:
at least one processor coupled to memory storing instructions for execution by the at least one processor to:
process first data using the first data model to obtain first intermediate data; and
send the first intermediate data to a second node through a first channel, wherein the first channel is updated based on error information of second intermediate data, information about the first channel, and the first intermediate data, the second intermediate data is a result of transmitting the first intermediate data to the second node through the first channel, and the first channel is a channel between the first node and the second node.

15. The distributed learning apparatus according to claim 14, wherein the first channel comprises a second channel and a third channel, and wherein the at least one processor is further configured to:
update the second channel based on the error information of the second intermediate data, information about the third channel, and the first intermediate data.

16. The distributed learning apparatus according to claim 15, wherein the at least one processor is further configured to:
receive first information sent by the second node, wherein the first information is determined based on the error information of the second intermediate data and the information about the third channel; and
update the second channel based on the first information and the first intermediate data.

17. The distributed learning apparatus according to claim 15, wherein the at least one processor is further configured to:
receive a third signal from the second node through the first channel, wherein the third signal is a signal obtained after a fourth signal is transmitted to the first node through the first channel, and the fourth signal includes a signal generated by mapping the error information of the second intermediate data to an air interface resource;
obtain first information based on the third signal, wherein the first information is determined based on the error information of the second intermediate data and the information about the third channel; and
update the second channel based on the first information and the first intermediate data.

18. The distributed learning apparatus according to claim 14, wherein the at least one processor is further configured to:
send a fifth signal to the second node through the first channel, wherein the fifth signal includes a signal generated by mapping third intermediate data to an air interface resource, and the third intermediate data is used to update the first channel.

19. The distributed learning apparatus according to claim 14, wherein the at least one processor is further configured to:
update the first data model based on error information of the first intermediate data to obtain a new first data model.

20. The distributed learning apparatus according to claim 19, wherein the at least one processor is further configured to:
receive second information sent by the second node, wherein the second information is used to obtain the error information of the first intermediate data;
wherein the second information includes the error information of the first intermediate data; or
the second information includes the error information of the second intermediate data and the information about the first channel, and the error information of the second intermediate data and the information about the first channel are used to determine the error information of the first intermediate data.
